(19) United States
(12) Patent Application Publication
(10) Pub. No.: US 2026/0274261 A1
(43) Pub. Date: Sep. 17, 2026

(54) VEHICLE CONTROL DEVICE

(71) Applicants: DENSO CORPORATION, Kariya-city (JP); AISIN CORPORATION, Kariya-city (JP); JTEKT CORPORATION, Kariya-city (JP); ADVICS CO., LTD., Kariya-city (JP)

(72) Inventor: Kota KAGA, Tokyo (JP)

(21) Appl. No.: 19/676,084

(22) Filed: May 13, 2026

Related U.S. Application Data
(63) Continuation of application No. PCT/JP2024/039180, filed on Nov. 4, 2024.

(30) Foreign Application Priority Data
Nov. 22, 2023 (JP) 2023-198402

(51) Int. Cl. B60W 30/18; B60W 40/105

(52) U.S. Cl. CPC B60W 30/18009; B60W 40/105; B60W 2520/10; B60W 2720/106

(57) ABSTRACT

A vehicle control device controls a driving force and a braking force of a vehicle passing over a change source which changes a vehicle speed by a wheel of the vehicle passing over or descending. The device includes: a passage determination unit that determines that the vehicle has passed over the change source, an impulse calculation unit that calculates an impulse acting on the vehicle when the vehicle passes over the change resource and that outputs impulse information corresponding to the calculated impulse, and a braking/driving calculation unit that calculates the driving force and the braking force after the vehicle has passed over the change source based on the impulse information. The impulse calculation unit calculates a velocity impulse based on the vehicle speed which changes when passing over the change source and a braking/driving impulse based on the driving force and the braking force which change when passing over the change source. The braking/driving calculation unit calculates, in response to the passage determination unit determining that the vehicle has passed over the change source, the driving force and the braking force based on a variation of a disturbance impulse when having passed over the change source, when the disturbance impulse is a difference between the velocity impulse and the braking/driving impulse.

### CROSS-REFERENCE TO RELATED APPLICATIONS

The present application is a continuation application of International Application No. PCT/JP2024/039180 filed on Nov. 4, 2024, which claims priority to Japanese Patent Application No. 2023-198402 filed on Nov. 22, 2023. The contents of these applications are incorporated herein by reference in their entirety.

### BACKGROUND

### 1. Technical Field

The present disclosure relates to a vehicle control device.

### 2. Related Art

When a vehicle is started while passing over a step, a larger driving force is necessary compared to when a vehicle is started on a flat road surface. However, when an accelerator is pressed further in order to acquire a large driving force for passing over a step, it is necessary to perform a braking operation immediately after the accelerator operation in order to prevent the vehicle speed from abruptly rising. For the accelerator operation and the braking operation which become necessary in this manner, a vehicle control device has been known which slightly imparts a braking force to a degree that a braking force is substantially not imparted to a wheel in response to determining that the vehicle runs on the step (for example, see JP2007045230A).

### SUMMARY

According to an aspect of the present disclosure, a vehicle control device configured to control a driving force and a braking force of a vehicle passing over a change source which changes a vehicle speed by a wheel of the vehicle passing over or descending, is provided. The vehicle control device comprises: a passage determination unit configured to determine that the vehicle has passed over the change source, an impulse calculation unit configured to calculate an impulse acting on the vehicle when the vehicle passes over the change source and that outputs impulse information corresponding to the calculated impulse, and a braking/driving calculation unit configured to calculate the driving force and the braking force after the vehicle has passed over the change source based on the impulse information. The impulse calculation unit is configured to calculate a velocity impulse based on the vehicle speed which changes when passing over the change source and a braking/driving impulse based on the driving force and the braking force which change when passing over the change source. The braking/driving calculation unit configured to calculate, in response to the passage determination unit determining that the vehicle has passed over the change source, the driving force and the braking force based on a variation of a disturbance impulse when having passed over the change source, when the disturbance impulse is a difference between the velocity impulse and the braking/driving impulse.

### BRIEF DESCRIPTION OF THE DRAWING

FIG. 1 is a schematic block diagram of a vehicle control device according to the present embodiment.

FIG. 2 is a diagram showing a state in which a vehicle passes over a step after colliding with the step.

FIG. 3 is a flowchart showing a control process executed by an automatic parking control device according to the present embodiment when a vehicle passes over a step.

FIG. 4 is a flowchart showing a control process executed by an automatic parking control device according to the present embodiment when a vehicle descends from a step.

FIG. 5 is a flowchart showing an automatic parking process executed by an automatic parking control device according to the present embodiment.

FIG. 6 is a diagram for explaining change of a velocity impulse when a vehicle has collided with a step.

FIG. 7 is a diagram for explaining change of a sum of a braking force and a driving force when a vehicle has collided with a step.

FIG. 8 is a diagram for explaining change of a disturbance impulse from before starting to when a wheel collides with a step.

FIG. 9 is a diagram for explaining a determination method from before starting to when a wheel having collided with a step has run on the step.

FIG. 10 is a diagram for explaining a variation of a disturbance impulse when a vehicle runs on a step.

FIG. 11 is a diagram for explaining a braking/driving impulse when a vehicle runs on a step.

FIG. 12 is a diagram for explaining change of a disturbance impulse when a running wheel has collided with a step.

FIG. 13 is a diagram for explaining change of a disturbance impulse when a wheel has descended from a step.

FIG. 14 is a diagram for explaining a variation of a disturbance impulse when a vehicle descends from a step.

FIG. 15 is a diagram for explaining a braking/driving impulse when a vehicle descends from a step.

### DETAILED DESCRIPTION OF THE PREFERRED EMBODIMENTS

A braking force imparted to a wheel when a vehicle runs on a step changes depending on a driving force for passing over a step. Therefore, when the braking force imparted to the wheel when the vehicle runs on the step is not appropriate, a speed of the vehicle cannot be appropriately adjusted.

For example, when the braking force actually imparted to the wheel is insufficient for the braking force necessary for preventing the vehicle speed from rapidly rising, the abrupt rise of the vehicle speed after having passed over the step may not be prevented. Further, when the braking force actually imparted to the wheel is excessively large for the braking force necessary for preventing the vehicle speed from abruptly rising, the vehicle may decelerate more than necessary after having passed over the step.

Therefore, when the vehicle runs on a road surface on which a change source to change the vehicle speed, such as a step, exists, the braking force and the driving force of the vehicle after having passed over the change source are required to be appropriately controlled. However, PTL 1 does not disclose the specific braking force to be imparted to the vehicle. This was found by a detailed study of the inventor.

In view of the above point, the present disclosure aims to provide a vehicle control device that can appropriately control a braking force and a driving force of a vehicle after having passed over the change source.

According to an aspect of the present disclosure, a vehicle control device configured to control a driving force and a braking force of a vehicle passing over a change source which changes a vehicle speed by a wheel of the vehicle passing over or descending, is provided. The vehicle control device comprises: a passage determination unit configured to determine that the vehicle has passed over the change source, an impulse calculation unit configured to calculate an impulse acting on the vehicle when the vehicle passes over the change source and that outputs impulse information corresponding to the calculated impulse, and a braking/driving calculation unit configured to calculate the driving force and the braking force after the vehicle has passed over the change source based on the impulse information. The impulse calculation unit is configured to calculate a velocity impulse based on the vehicle speed which changes when passing over the change source and a braking/driving impulse based on the driving force and the braking force which change when passing over the change source. The braking/driving calculation unit configured to calculate, in response to the passage determination unit determining that the vehicle has passed over the change source, the driving force and the braking force based on a variation of a disturbance impulse when having passed over the change source, when the disturbance impulse is a difference between the velocity impulse and the braking/driving impulse.

Here, the disturbance impulse as the difference between the velocity impulse and the braking/driving impulse is an impulse that is received from a disturbance when the vehicle passes over the change source, and becomes a factor for an abrupt rise of the vehicle speed of the vehicle after having passed over the change source. Therefore, the braking force and the driving force after having passed over the change source is suppressed from becoming excessive or insufficient by calculating the braking force and the driving force based on a variation of the disturbance impulse which becomes a factor for the abrupt rise of the vehicle speed of the vehicle after having passed over the change source. Therefore, the braking force and the driving force of the vehicle immediately after having passed over the change source can be appropriately controlled.

Note that a bracketed reference sign attached to each constituent or the like denotes an example of the correspondence relation between the constituent or the like and a specific constituent or the like according to the later-described embodiment.

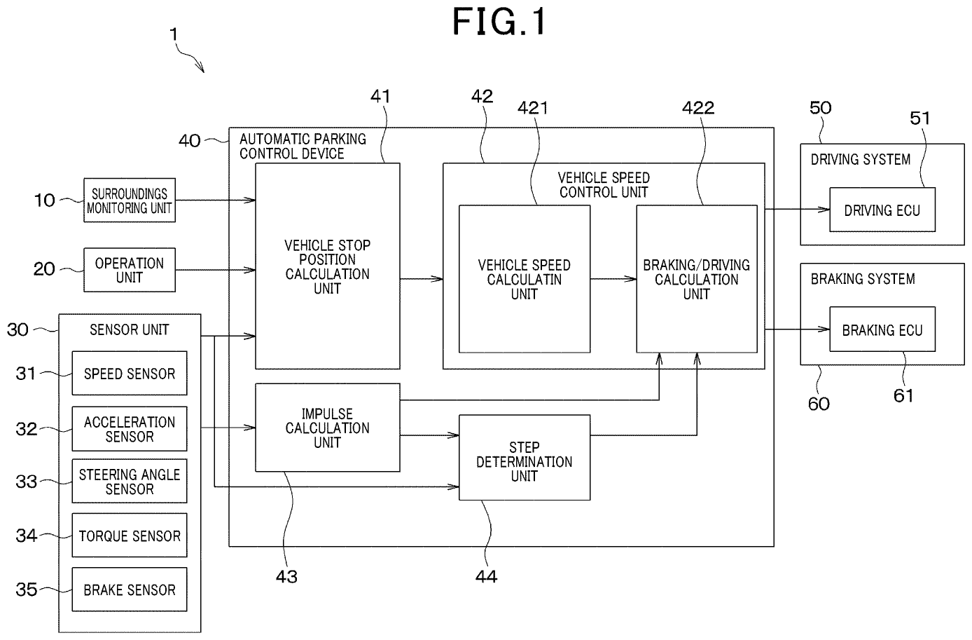

An embodiment of the present disclosure will be described using FIG. 1 to FIG. 15. In the present disclosure, an example in which a vehicle control device 1 is applied to an electric vehicle having an automatic parking system will be described. The automatic parking system is a control system for automatically parking a subject vehicle in a parking space. The automatic parking system executes an automatic parking process and controls actions of various control target devices mounted to the subject vehicle so that the subject vehicle is run and parked in the parking space. The vehicle control device 1 of the present disclosure is configured integrally with the automatic parking system and can execute the automatic parking process executed by the automatic parking system.

As shown in FIG. 1, the vehicle control device 1 includes a surroundings monitoring unit 10, an operation unit 20, a sensor unit 30, an automatic parking control device 40, a driving system 50, and a braking system 60. The surroundings monitoring unit 10, the operation unit 20, the sensor unit 30, the automatic parking control device 40, the driving system 50, and the braking system 60 are used for the vehicle control device 1 executing the automatic parking process.

The surroundings monitoring unit 10 is an autonomous sensor that monitors a surrounding environment of the subject vehicle and detects a moving dynamic target such as a pedestrian and another vehicle and a resting static target such as a structure on a road. The surroundings monitoring unit 10 is configured by including, for example, a camera that takes a surroundings image of the subject vehicle and a sonar that outputs ultrasonic waves as probe waves and also acquires reflected waves thereof to detect an object existing in the surroundings of the subject vehicle. Further, the surroundings monitoring unit 10 may include a millimeter-wave radar that outputs millimeter waves as probe waves and light detection and ranging (LIDAR) that outputs laser beams as probe waves. The surroundings monitoring unit 10 is electrically connected to the automatic parking control device 40 and outputs a signal containing the detected information as sensing information to the automatic parking control device 40 every predetermined sampling period.

The operation unit 20 is a user interface that allows various instructions to be given to the vehicle control device 1 by an operation of an operator such as a driver. The operation unit 20 is configured by including, for example, an automatic parking start switch for the operator inputting a start signal of automatic parking. The automatic parking start switch is disposed, for example, around a center of an instrument panel. Note that the automatic parking start switch may be configured so as to be displayed on a touch-panel display. The operation unit 20 is electrically connected to the automatic parking control device 40 and transmits various signals input through the operation unit 20 to the automatic parking control device 40.

The sensor unit 30 is a sensor that detects various pieces of information regarding motion of the subject vehicle. The sensor unit 30 is configured by including, for example, as shown in FIG. 1, a speed sensor 31 that detects a vehicle speed of the subject vehicle, an acceleration sensor 32 that detects an acceleration of the subject vehicle, and a steering angle sensor 33 that detects a steering angle of a steering wheel. Further, the sensor unit 30 is configured by including a torque sensor 34 that detects output torque of the driving system 50 which outputs a driving force for running the subject vehicle as the electric vehicle, a brake sensor 35 that detects a braking force that brakes the subject vehicle, and the like. Note that although not shown, the sensor unit 30 may be configured by including a yaw rate sensor and the like. The sensor unit 30 is electrically connected to the automatic parking control device 40 and transmits various pieces of information detected by the sensor unit 30 to the automatic parking control device 40.

The speed sensor 31 is a sensor that detects the speed of the subject vehicle. The speed sensor 31 of the present embodiment is configured by a wheel speed sensor that detects a revolution of a wheel of the subject vehicle. The speed sensor 31 is provided near each of four wheels of the subject vehicle and outputs detection signals of the quantity depending on a revolution angle of each of the four wheels as wheel speed pulses. The speed sensor 31 outputs, every time the wheel revolves once, a pulse signal the previously set designed number of times (for example, 96 times) depending on the revolution angle of the wheel. In the present embodiment, the speed sensor 31 functions as a speed detection unit that outputs information corresponding to the detected vehicle speed.

The acceleration sensor 32 is a sensor that detects the acceleration of the subject vehicle based on an inertia force associated with acceleration of the subject vehicle. The acceleration sensor 32 is, for example, fixed to the subject vehicle and detects the accelerations in respective directions along three axes defined for the subject vehicle, specifically, in a front and rear direction, a left and right direction, and an upper and lower direction of the subject vehicle.

The steering angle sensor 33 is a sensor that detects an orientation and an operation amount of the steering wheel. The steering angle sensor 33 outputs the detection signal depending on the steering operation when the driver performs a steering operation, and outputs the detection signal depending on the steering angle of the steering wheel set by the automatic parking process when the automatic parking system executes the automatic parking process.

The torque sensor 34 is a sensor that detects the driving force of the subject vehicle by detecting output torque of an unshown motor for running of the driving system 50. When the driver performs an operation of pressing an accelerator pedal, the torque sensor 34 outputs the detection signal depending on the output torque of the motor for running which acts depending on the pressing amount of the accelerator pedal. When the automatic parking system executes the automatic parking process, the torque sensor 34 outputs the detection signal depending on the output torque of the motor for running of the driving system 50 controlled by the automatic parking process.

The brake sensor 35 is a sensor that detects the braking force that occurs in the braking system 60 when the subject vehicle is decelerated or stopped. When the driver performs the operation of pressing the brake pedal, the brake sensor 35 outputs the detection signal depending on the braking force which occurs in the braking system 60 depending on the pressing amount of the brake petal. When the automatic parking system executes the automatic parking process, the brake sensor 35 outputs the detection signal depending on the braking force which occurs in the braking system 60 controlled by the automatic parking process.

The driving system 50 contains a later-described driving ECU 51. The driving system 50 includes, for example, the unshown motor for running that functions as a power source of the subject vehicle and an inverter that supplies power to the motor for running. The driving system 50 controls power supplied to the inverter to adjust a revolution force of the motor for running transmitted to the wheel, thereby controlling the output driving force.

The braking system 60 contains a later-described braking ECU 61. The braking system 60 includes, for example, an unshown brake rotor, brake pad, wheel cylinder, and the like. The braking system 60 adjusts a brake fluid pressure supplied to the wheel cylinder to control a friction force generated by pressing the brake pad against the brake rotor, thereby controlling the output braking force. The braking system 60 controls the respective braking forces generated in the four wheels.

The automatic parking control device 40 is a control device that executes the automatic parking process to control actions of various control target devices in response to the start signal of automatic parking being input. The automatic parking control device 40 is configured by a micro-computer containing a CPU, a ROM, a RAM, and the like and peripheral circuits thereof. Then, the automatic parking control device 40 performs various calculations and processes based on control programs stored in the ROM and controls actions of various control target devices connected to an output side thereof. Note that the ROM and the RAM of the automatic parking control device 40 are configured by non-transitory tangible storage media.

The automatic parking control device 40 includes a vehicle stop position calculation unit 41, a vehicle speed control unit 42, an impulse calculation unit 43, and a step determination unit 44. In response to the start signal of automatic parking being input, the automatic parking control device 40 executes the control programs stored in the ROM to function as the vehicle stop position calculation unit 41, the vehicle speed control unit 42, the impulse calculation unit 43, and the step determination unit 44. Alternatively, the automatic parking control device 40 may include a plurality of circuit modules corresponding to the vehicle stop position calculation unit 41, the vehicle speed control unit 42, the impulse calculation unit 43, and the step determination unit 44.

The vehicle stop position calculation unit 41 recognizes the surroundings environment of the subject vehicle based on the sensing information input from the surroundings monitoring unit 10, determines a target vehicle stop position as a target position in which the subject vehicle is to be parked, and determines a target running route to the target vehicle stop position. The vehicle stop position calculation unit 41 determines the target vehicle stop position and the target running route, based on, for example, the detection signal containing imaging data taken by the camera of the surroundings monitoring unit 10 and information regarding objects detected by the sonar, the millimeter-wave radar, and the LIDAR.

The vehicle speed control unit 42 determines a set value of each of the control target devices to be activated in order to park the subject vehicle in the target vehicle stop position. The vehicle speed control unit 42 includes a vehicle speed calculation unit 421 that computes and calculates a set value of the vehicle speed when running the subject vehicle from a current position to the target vehicle stop position and a braking/driving calculation unit 422 that calculates the driving force and the braking force when running the subject vehicle from the current position to the target vehicle stop position.

The vehicle speed calculation unit 421 calculates a target speed that is a target vehicle speed in the target running route when moving the subject vehicle from the current position to the target vehicle stop position along the target running route calculated by the vehicle stop position calculation unit 41. The vehicle speed calculation unit 421 transmits information of the calculated target speed to the braking/driving calculation unit 422.

The braking/driving calculation unit 422 calculates the driving force and the braking force necessary for running the subject vehicle at the target speed calculated by the vehicle speed calculation unit 421 and calculates the set value of each of the control target devices necessary for acquiring the calculated driving force and braking force.

For example, the braking/driving calculation unit 422 calculates, as the target number of revolutions of the motor for running, the driving force of the motor for running necessary for running the subject vehicle at the target speed from the current position to the target vehicle stop position along the target running route. Further, for example, the braking/driving calculation unit 422 calculates, as a braking force, a target fluid pressure of brake fluid supplied to the wheel cylinder provided to each wheel when running the subject vehicle at the target speed from the current position to the target vehicle stop position along the target running route.

The braking/driving calculation unit 422 transmits information of the calculated driving force to the driving ECU 51 of the driving system 50 and transmits information of the calculated braking force to the braking ECU 61 of the braking system 60.

The driving ECU 51 controls power supplied to the inverter such that the number of revolutions of the motor for running becomes the target number of revolutions set by the braking/driving calculation unit 422. The driving ECU 51 controls the driving force output by the driving system 50 by controlling power supplied to the inverter such that the number of revolutions of the motor for running approaches the target number of revolutions.

The braking ECU 61 controls an action of an unshown actuator that adjusts the brake fluid pressure such that the brake fluid pressure to the wheel cylinder becomes the target fluid pressure set by the braking/driving calculation unit 422. The braking ECU 61 controls the braking force output by the braking system 60 by controlling the actuator such that the brake fluid pressure approaches the target fluid pressure.

Note that although not shown, the vehicle control device 1 of the present embodiment includes a steering system and calculates a target steering angle of the steering wheel when running the subject vehicle from the current position to the target vehicle stop position along the target running route in response to the start signal of automatic parking being input to the automatic parking control device 40. Then, an action of a steering motor that revolves the steering wheel is controlled such that the steering angle of the steering wheel becomes the target steering angle by the steering system.

In response to the start signal of automatic parking being input, the automatic parking control device 40 transmits various pieces of information necessary for parking the subject vehicle in the target vehicle stop position to each of the driving system 50, the braking system 60, and the steering system. In response to receiving various pieces of information from the automatic parking control device 40, the driving ECU 51 of the driving system 50 controls an action of the motor for running such that the output driving force approaches the target driving force calculated by the braking/driving calculation unit 422. In response to receiving various pieces of information from the automatic parking control device 40, the braking ECU 61 of the braking system 60 controls the actuator such that the output braking force approaches the target braking force calculated by the braking/driving calculation unit 422.

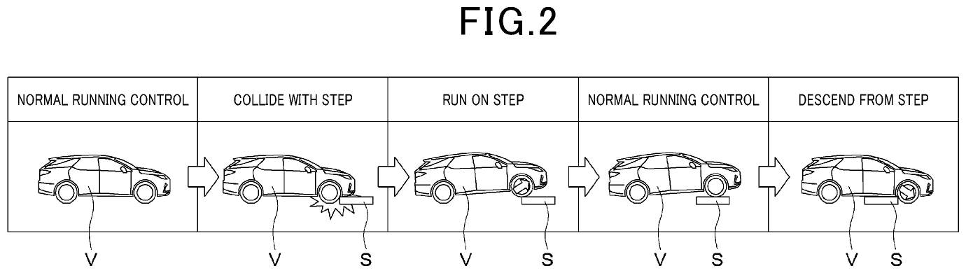

As shown in FIG. 2, a step S sometimes exists on a running road on which a vehicle V runs. The step S has a predetermined height, becomes an obstruction of the running of the vehicle V, and lowers a speed of the vehicle V when a wheel of the running vehicle V has collided with the step S. Further, when the stationary vehicle V starts from a state in which the wheel is in contact with the step S, the step S obstructs start of the vehicle V thereby to lower the acceleration and the speed of the vehicle V compared to when the step S does not exist.

Further, when the vehicle V, which is running on the running road having a flat road surface at a constant speed or which has begun running from a stationary state, descends from the step S, the step S raises the speed of the vehicle V. A reason why the speed of the vehicle V rises when the vehicle V descends from the step S is that the vehicle V is subjected to gravity when descending from the step S, and the lower side in the vertical direction, i.e., in the weight direction, is subjected to a load attributable to the gravity, so that potential energy is converted into kinetic energy. In this manner, the step S becomes a change source that changes the speed of the vehicle V by the wheel of the vehicle V passing over the step S or descending from the step S.

When the running vehicle V is run while passing over the step S and when the stationary vehicle V is started while passing over the step S, a larger driving force is necessary compared to when run on the flat road surface on which the step S does not exist or when started on the flat road surface on which the step S does not exist. Therefore, in calculating the driving force necessary for running the subject vehicle at the target speed, the braking/driving calculation unit 422 increases a set value of the driving force for the wheel passing over the step S compared to when the step S does not exist. Further, in calculating the braking force necessary for running the subject vehicle at the target speed, the braking/driving calculation unit 422 decreases a set value of the braking force when the vehicle V passes over the step S compared to when the step S does not exist.

However, when the driving force is increased, and the braking force is decreased for passing over the step S, the vehicle V may abruptly accelerate immediately after the wheel has run on the step S. That is, the driving force increased for passing over the step S may cause the vehicle V to abruptly accelerate. Therefore, for preventing the vehicle speed from abruptly rising, it may be required to lower the driving force immediately after the wheel has run on the step S compared to the set value set for passing over the step S. Further, it may be required to raise the braking force immediately after the wheel has run on the step S compared to the set value set for passing over the step S.

Therefore, the braking/driving calculation unit 422 is required to decrease the set value of the driving force immediately after the wheel has run on the step S compared to before the wheel runs on the step S or to increase the set value of the braking force immediately after the wheel has run on the step S compared to before the wheel runs on the step S.

Further, since potential energy is converted into kinetic energy by the gravity when the vehicle V descends from the step S, and the vehicle speed rises, the vehicle speed may abruptly rise after the wheel descended from the step S and passed over the step S. Therefore, for preventing the vehicle speed from abruptly rising, it may be required to lower the driving force immediately after the wheel has descended from the step S compared to the set value set before descending from the step S. Further, it may be required to raise the braking force immediately after the wheel has descended from the step S compared to the set value set before descending from the step S.

Therefore, the braking/driving calculation unit 422 is required to decrease the set value of the driving force immediately after the wheel has descended from the step S compared to before the wheel descends from the step S or to increase the set value of the braking force immediately after the wheel descends from the step S compared to before the wheel descends from the step S.

Therefore, the vehicle control device 1 of the present embodiment accurately determines passage over the step S when passing over the step S which becomes the change source that changes the speed of the vehicle V, and appropriately controls the driving force and the braking force of the vehicle V immediately after having passed over the step S. The vehicle control device 1 of the present embodiment includes, as shown in FIG. 1, the step determination unit 44 that determines the passage over the step S and the impulse calculation unit 43 that acquires information necessary for calculating the driving force and the braking force immediately after the passage over the step S when the step determination unit 44 determines the passage over the step S.

The step determination unit 44 detects that the wheel has collided with the step S when the wheel of the running vehicle V has collided with the step S and also detects that the wheel is in a state of being in contact with the step S when the stationary vehicle starts from a state in which the wheel is in contact with the step S. Further, the step determination unit 44 detects that the wheel has run on the step S when the wheel has run on the step S after the running vehicle V collided with the step S and when the wheel has run on the step S after the stationary vehicle V with the wheel being in contact with the step S started. Further, the step determination unit 44 detects that the wheel has descended from the step S when the wheel of the running vehicle V has descended from the step S. The step determination unit 44 determines the passage over the step S based in information acquired from the impulse calculation unit 43. The step determination unit 44 of the present embodiment functions as a passage determination unit that determines the passage over the step S which is the change source. Details of the determination method will be described later.

As information necessary for the step determination unit 44 detecting these detections, the impulse calculation unit 43 calculates an impulse acting on the vehicle V by the passage over the step S. In addition, the impulse calculation unit 43 calculates the impulse acting on the vehicle V by the passage over the step S, as information necessary for the braking/driving calculation unit 422 appropriately calculating the driving force and the braking force of the vehicle V immediately after the passage over the step S. The impulse calculation unit 43 calculates the impulse acting on the vehicle V by the passage over the step S based on various pieces of information transmitted from the sensor unit 30 and transmits impulse information corresponding to the calculated impulse to the step determination unit 44 and the braking/driving calculation unit 422. Details of the calculation method of the impulse and the calculation method of the driving force and the braking force immediately after the passage over the step S will be described later.

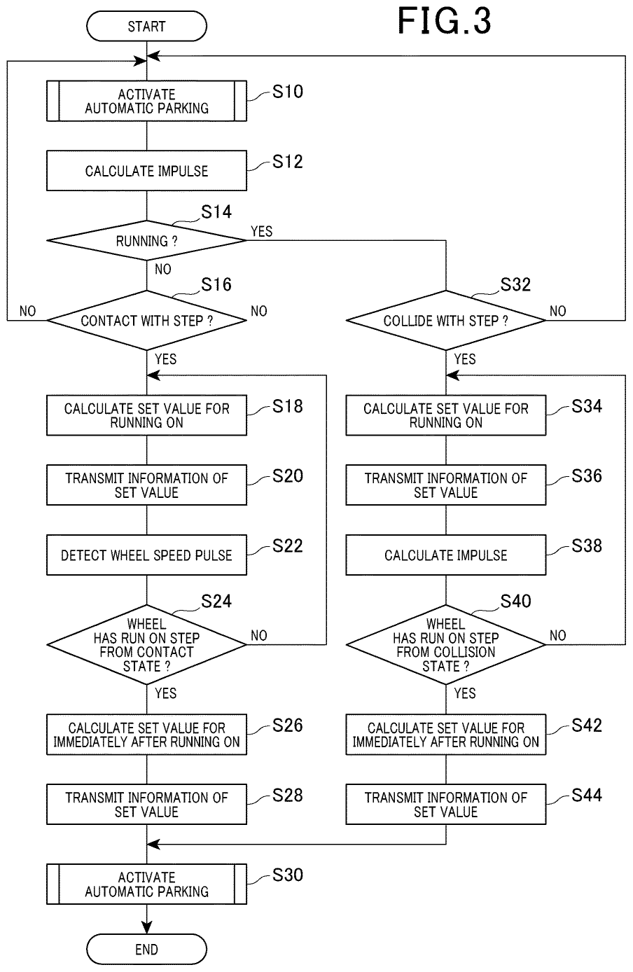

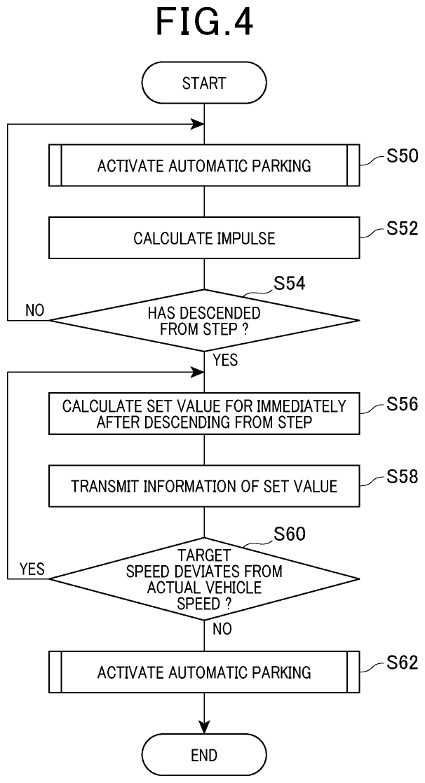

Subsequently, an example of an action process in which the automatic parking control device 40 of the vehicle control device 1 of the present embodiment executes the automatic parking process will be described with reference to flowcharts shown in FIG. 3 and FIG. 4 described later. Control processes shown in FIG. 3 and FIG. 4 are, for example, executed periodically in response to the operator operating the automatic parking start switch to input the start signal of automatic parking to the vehicle control device 1, and end when the vehicle V is parked to complete the automatic parking process. Further, the control processes shown in FIG. 3 and FIG. 4 contain the control process executed when the vehicle V passes over the step S.

Specifically, the control process shown in FIG. 3 contains the control process executed after the vehicle V has run on the step S from a state before running on the step S. Further, the control process shown in FIG. 4 contains the control process executed after the vehicle V has descended from the step S from a state of having run on the step S. The control processes shown in FIG. 3 and FIG. 4 may be executed at the same time, or the control process shown in FIG. 4 may be executed after the control process shown in FIG. 3 has been executed. In the present embodiment, an example in which the control processes shown in FIG. 3 and FIG. 4 are executed at the same time will be described.

First, the control process containing the control process executed after the vehicle V has run on the step S from a state before running on the step S will be described with reference to FIG. 3 and FIG. 5.

In response to the start signal of automatic parking being input, the automatic parking control device 40 first starts the automatic parking action in step S10. Specifically, as shown in FIG. 5, the automatic parking control device 40 first acquires the sensing information from the surroundings monitoring unit 10 in step S100. For example, the automatic parking control device 40 acquires imaging data from the camera and also acquires information of the objects existing in respective detection ranges of the sonar, the millimeter-wave radar, and the LIDAR from the sonar, the millimeter-wave radar, and the LIDAR, as the sensing information.

Subsequently, in step S110, the automatic parking control device 40 recognizes the surroundings environment of the subject vehicle based on various pieces of information acquired by the vehicle stop position calculation unit 41 from the surroundings monitoring unit 10 and determines the target vehicle stop position and the target running route.

Subsequently, in step S120, the vehicle speed control unit 42 calculates the respective set values of the control target devices to be activated for stopping the subject vehicle in the target vehicle stop position. Specifically, the vehicle speed calculation unit 421 calculates the target speed for moving the vehicle V from the current position to the target vehicle stop position along the target running route determined by the vehicle stop position calculation unit 41. Then, the braking/driving calculation unit 422 calculates the driving force necessary for running the subject vehicle at the target speed calculated by the vehicle speed calculation unit 421 along the target running route determined by the vehicle stop position calculation unit 41. Further, the braking/driving calculation unit 422 calculates the braking force necessary for running the subject vehicle at the target speed calculated by the vehicle speed calculation unit 421 along the target running route determined by the vehicle stop position calculation unit 41. In addition, the braking/driving calculation unit 422 calculates the target steering angle of the steering wheel necessary for running the subject vehicle along the target running route.

Subsequently, in step S130, the automatic parking control device 40 transmits information of the various set values calculated by the braking/driving calculation unit 422 to the driving system 50, the braking system 60, and the steering system. Specifically, the braking/driving calculation unit 422 transmits information of the driving force to the driving ECU 51 of the driving system 50, transmits information of the calculated braking force to the braking ECU 61 of the braking system 60, and transmits information of the calculated steering angle to the steering system.

Accordingly, respective actions of the motor for running that outputs the driving force, the actuator that adjusts the brake fluid pressure which outputs the braking force, and the steering motor that controls the steering angle are started, and the automatic parking is performed.

Subsequently, in step S140, the automatic parking control device 40 determines whether the current position of the vehicle Vis the target vehicle stop position. In response to determining that the current position of the vehicle V is the target vehicle stop position, the automatic parking control device 40 determines that the vehicle V has run to the target vehicle stop position and ends the automatic parking process. The automatic parking control device 40 repeatedly executes the process of step S100 to step S140 until it is determined in step S140 that the current position of the vehicle Vis the target vehicle stop position. That is, the automatic parking action is continued until it is determined in step S140 that the subject vehicle has run to the target vehicle stop position.

By the way, when the step S shown in FIG. 2 exists on the running road on which the vehicle V runs, the wheel of the vehicle V may be brought into contact with or collide with the step S. For example, when the step S exists on the road surface on which the vehicle V runs, the wheel of the vehicle V may collide with the step S. Further, when the vehicle V stops in a state in which the wheel of the vehicle V has collided with the step S, the wheel becomes in a state of having collided with the step S before starting, that is, in a state in which the wheel of the stationary vehicle V is in contact with the step S.

Then, as described above, when the vehicle V running on the road surface collides with the step S and passes over the step S, the driving force for passing over the step S may be required to be larger compared to before colliding with the step S. Further, when the vehicle V is started while passing over the step S in a state in which the wheel of the stationary vehicle Vis in contact with the step S, the driving force for passing over the step S is required to be larger compared to when the step S does not exist. Then, as described above, in order to prevent the vehicle speed after having passed over the step S from abruptly rising, the driving force after having passed over the step S needs to be lower than the driving force set to be large for passing over the step S. Further, in order to prevent the vehicle speed after having passed over the step S from abruptly rising, the braking force after having passed over the step S needs to be greater than the braking force before passing over the step S.

Therefore, in the control process shown in FIG. 3, the automatic parking control device 40 of the present embodiment executes the process of step S12 and later during the automatic parking action and determines, before the vehicle V runs on the step S, whether the wheel is in contact with or collides with the step S. Then, when the wheel is in contact with or collides with the step S, the automatic parking control device 40 sets the set value of the driving force to a magnitude that allows for passing over the step S and also lowers the driving force after having passed over the step S. The control process of step S12 and later will be described.

In the automatic parking control device 40, the impulse calculation unit 43 calculates the impulse acting on the vehicle V in step S12 during the automatic parking action. Then, in the automatic parking control device 40, the step determination unit 44 determines, in step S16 and step S32, whether the wheel of the vehicle V is in contact with or collides with the step S based on the impulse calculated by the impulse calculation unit 43.

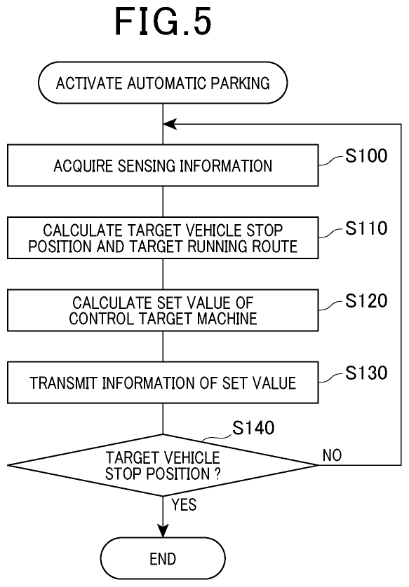

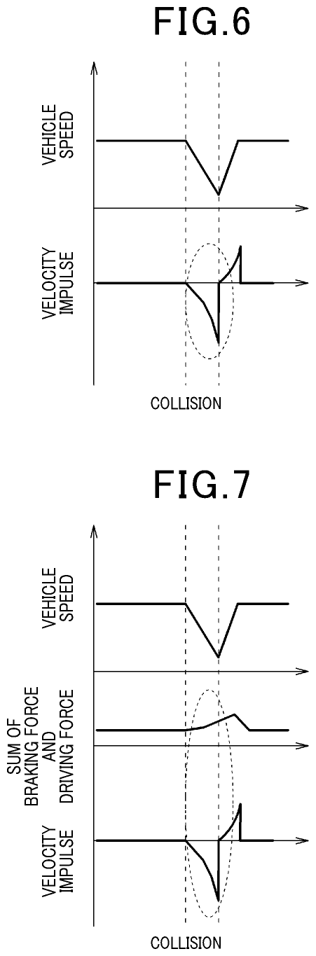

When the step S exists on the road surface, the impulse calculation unit 43 calculates the impulse acting on the vehicle V when the vehicle V passes over the step S, based on various pieces of information acquired from the sensor unit 30. Here, the impulse acting on the vehicle V will be described with reference to FIG. 6 and FIG. 7.

The impulse acting on the vehicle V is calculated based on the speed when the vehicle V runs, that is, the vehicle speed. Hereinafter, the impulse calculated based on the vehicle speed is referred to as a velocity impulse. The velocity impulse acting on the vehicle V when the vehicle V runs on the road surface for a predetermined time is calculated by integrating a value calculated by multiplying the weight of the vehicle V by the acceleration of the vehicle V. For example, when the weight of the vehicle Vis vehicle weight M, and the acceleration of the vehicle V is vehicle acceleration a, the velocity impulse is calculated based on equation 1 shown below. The impulse calculation unit 43 calculates, as the impulse information, the velocity impulse based on equation 1.

Velocity impulse=∫(vehicle weight M×vehicle acceleration a) (1)

Then, as shown in FIG. 6, the velocity impulse when the vehicle speed changes in such a manner as continuing lowering for a certain time and thereafter continuing increasing for a certain time is less than 0 while the vehicle speed is lowering, and is more than 0 while the vehicle speed is increasing. Note that vehicle acceleration a is 0 in a state in which the vehicle speed is constant without acceleration and deceleration or in a state in which the vehicle Vis stationary. In this case, the velocity impulse is 0.

The impulse calculation unit 43 acquires, from the sensor unit 30, information of vehicle acceleration a for calculating the velocity impulse. As vehicle acceleration a for calculating the velocity impulse, information of the acceleration detected by the acceleration sensor 32 of the sensor unit 30 may be used, or a differential value calculated by differentiating the speed detected by the speed sensor 31 may be used. In the present embodiment, the impulse calculation unit 43 uses the differential value of the speed detected by the speed sensor 31 as vehicle acceleration a. As vehicle weight M, a previously set design value may be used.

As shown in FIG. 6, the velocity impulse lowers in magnitude with lowering of the vehicle speed. Therefore, when the wheel of the running vehicle V running on the road surface collides with the step S so that the vehicle speed lowers, the velocity impulse decreases compared to before colliding with the step S.

Then, when the vehicle V has collided with the step S, the set value of the driving force set by the braking/driving calculation unit 422 for passing over the step S may be required to be increased to be greater than the set value set in step S120 of the previous control period. Further, in order to prevent the vehicle speed from abruptly rising immediately after the wheel has run on the step S by the increased driving force, the set value of the driving force set by the braking/driving calculation unit 422 may be required to be lowered to be less than the set value increased for passing over the step S.

In this manner, when the running vehicle V has collided with the step S, the braking/driving calculation unit 422 may need to change the set value of the driving force. Therefore, it is required to accurately detect that the wheel has collided with the step S. Further, in order for the braking/driving calculation unit 422 to decrease the set value of the driving force immediately after the wheel has run on the step S, it is required to accurately detect that the wheel has run on the step S after the wheel collided with the step S.

Further, when the vehicle Vis stopped in a state in which the wheel has collided with the step S, the wheel of the vehicle V becomes in a state in which the wheel has collided with the step S before starting and in which the wheel of the stationary vehicle V is in contact with the step S. When the wheel has collided with the step S before staring, and the vehicle V is started from a state in which the wheel is in contact with the step S, the running of the vehicle Vis obstructed by the step S. Therefore, when the vehicle Vis started and passes over the step S, the set value of the driving force set by the braking/driving calculation unit 422 for passing over the step S may be required to be increased to be greater than the set value set in step S120 of the previous control period.

In this manner, when the vehicle Vis started from a state in which the wheel is in contact with the step S, the braking/driving calculation unit 422 may need to change the set value of the driving force. Therefore, it is required to accurately detect that the wheel is in a state of being in contact with the step S before starting.

By the way, when the vehicle V is started from a state in which the wheel is in contact with the step S, the vehicle speed is 0 until the vehicle V begins running, that is, until the wheel begins running on the step S. Therefore, the velocity impulse does not change from 0 until the wheel begins running on the step S. Then, when the vehicle V begins running, and the wheel begins running on the step S, the velocity impulse increases from 0.

However, when the wheel of the vehicle V has not collided with the step S before starting, and the vehicle V is started from a state in which the wheel is not in contact with the step S, the vehicle speed is also 0 until the vehicle V begins running. Therefore, when the vehicle V is started from a state in which the wheel is not in contact with the step S, the velocity impulse also does not change from 0 until the wheel begins running on the step S. Then, when the vehicle V begins running, the velocity impulse increases from 0.

In this manner, the velocity impulse is 0 in magnitude until the vehicle V begins running regardless of whether the wheel is in a state of being in contact with the step S, and increases from 0 when the vehicle V begins running.

Therefore, the state in which the wheel is in contact with the step S before starting cannot be accurately detected by a method of detecting a change in velocity impulse. Further, even if an increase in velocity impulse is detected, it cannot be determined whether the vehicle V started from a state in which the wheel is in contact with the step S or from a state in which the wheel is not in contact with the step S.

However, the driving force and the braking force differ between when the velocity impulse lowers due to collision of the wheel with the step S and when the velocity impulse lowers due to the braking operation by the driver. Therefore, it can be accurately detected that the wheel of the vehicle Vis in contact with or collides with the step S, based on a difference in driving force and braking force. The difference in driving force and braking force between when the velocity impulse lowers due to collision of the wheel with the step S and when the velocity impulse lowers due to the braking operation by the driver will be described with reference to FIG. 7.

During execution of the automatic parking process of repeatedly executing the process of step S100 to step S140, the vehicle speed control unit 42 adjusts the driving force and the braking force in order to run the subject vehicle at the target speed. Then, for running the vehicle V at a constant vehicle speed or with acceleration during execution of the automatic parking process, the braking/driving calculation unit 422 sets the set value of the driving force to equal to or greater than the set value of the braking force. On the other hand, for stopping or decelerating the vehicle V during execution of the automatic parking process, the braking/driving calculation unit 422 increases the set value of the braking force to more than the set value of the driving force.

Further, when the wheel collides with the step S resulting in lowering in vehicle speed while the vehicle Vis running at the target speed during execution of the automatic parking process, the vehicle speed deviates from the target speed. Then, the automatic parking control device 40 repeatedly executes the process of step S100 to step S140 so that the braking/driving calculation unit 422 increases the set value of the driving force and decreases the set value of the braking force such that the vehicle speed approaches the target speed.

Therefore, when the velocity impulse lowers due to collision of the wheel with the step S during execution of the automatic parking process, the braking/driving calculation unit 422 gradually increases the set value of the driving force and gradually increases the set value of the braking force as the velocity impulse gradually lowers. Therefore, as shown in FIG. 7, when the velocity impulse lowers due to collision of the wheel with the step S, a total value calculated by adding the driving force output by the driving system 50 to the braking force output by the braking system 60 increases as the velocity impulse lowers. This is because when the vehicle V is to be accelerated, the braking/driving calculation unit 422 sets the set value of the driving force to be larger than the set value of the braking force.

On the other hand, although not shown, when the velocity impulse lowers due to a braking operation by the driver, the total value calculated by adding the driving force output by the driving system 50 to the braking force output by the braking system 60 decreases as the velocity impulse lowers. This is because when the vehicle V is to be decelerated or stopped, the braking/driving calculation unit 422 sets the set value of the braking force to be larger than the set value of the driving force.

In this manner, the driving force and the braking force differ between when the velocity impulse lowers due to collision of the wheel with the step S and when the velocity impulse lowers due to the braking operation by the driver. Then, the impulse acting on the vehicle V is calculated based on the driving force and the braking force in addition to based on the vehicle speed.

Further, when the vehicle speed changes by passing over the step S, a difference occurs between the velocity impulse that is calculated based on the vehicle speed and the impulse that is calculated based on the driving force and the braking force. In addition, when starting the vehicle V from a state in which the wheel is in contact with the step S, a difference also occurs between the velocity impulse that is calculated based on the vehicle speed and the impulse that is calculated based on the driving force and the braking force. Hereinafter, the impulse calculated based on the driving force and the braking force is defined as a braking/driving impulse.

The braking/driving impulse is the impulse acting on the vehicle V and is calculated based on the driving force output by the driving system 50 and the braking force output by the braking system 60 for running the vehicle V.

In the vehicle control device 1 of the present embodiment, the impulse calculation unit 43 calculates the braking/driving impulse in addition to the velocity impulse. The braking/driving impulse acting on the vehicle V when the vehicle V runs on the road surface for a predetermined time is calculated by integrating the value calculated by adding the driving force output by the driving system 50 to the braking force output by the braking system 60. For example, when the driving force output by the driving system 50 is drive F1, and the braking force output by the braking system 60 is brake F2, the braking/driving impulse is calculated according to equation 2 shown below. The impulse calculation unit 43 calculates, as the impulse information, the braking/driving impulse based on equation 2.

Braking/driving impulse=(drive F1+brake F2) (2)

When a sum of drive F1 and brake F2 becomes smaller than 0 because drive F1 becomes smaller than brake F2, the braking/driving impulse becomes smaller than 0. That is, when adjusting drive F1 and brake F2 in order to decelerate or stop the vehicle V, the braking/driving impulse becomes smaller than 0.

On the other hand, when the sum of drive F1 and brake F2 becomes larger than 0 because drive F1 becomes larger than brake F2, the braking/driving impulse becomes larger than 0. That is, when drive F1 and brake F2 are adjusted in order to accelerate the vehicle V, the braking/driving impulse becomes larger than 0.

Further, for example, in a state in which drive F1 and brake F2 are the same in magnitude, and the vehicle V is running at a constant speed without acceleration and deceleration or is stationary, the braking/driving impulse becomes 0.

Drive F1 may be calculated based on the set value set by the braking/driving calculation unit 422, that is, based on the target number of revolutions of the motor for running, or may be calculated based on a measurement value of the output torque of the motor for running detected by the torque sensor 34. Further, brake F2 may be calculated based on the set value set by the braking/driving calculation unit 422, that is, based on the target fluid pressure of the brake fluid supplied to the wheel cylinder. Further, brake F2 may be calculated based on a measurement value of the braking force occurring in the braking system 60 detected by the brake sensor 35.

In calculating the braking/driving impulse, an error of the calculated braking/driving impulse can be suppressed by using the measurement value detected by the torque sensor 34 and the measurement value detected by the brake sensor 35, compared to by using the respective set values of the driving force and the braking force set by the braking/driving calculation unit 422.

In this manner, similarly to the velocity impulse, the braking/driving impulse rises in magnitude when accelerating the vehicle V and lowers in magnitude when decelerating the vehicle V. Then, when the vehicle V is not subjected to an outside force, the velocity impulse and the braking/driving impulse become substantially the same in magnitude. That is, when the vehicle V is not influenced by disturbance, the velocity impulse and the braking/driving impulse become substantially the same in magnitude. This is because when not influenced by disturbance, the change of the vehicle speed is determined by the change of the driving force and the change of the braking force.

However, as described above, when the wheel of the running vehicle V running on the road surface collides with the step S, and the vehicle speed lowers, the velocity impulse becomes lower as the vehicle speed reduces. On the other hand, the braking/driving impulse is not influenced by the change of the vehicle speed even when the wheel collides with the step S, and the vehicle speed lowers, unless the driving force and the braking force lower. Further, as shown in FIG. 7, even when the wheel collides with the step S, and the vehicle speed and the velocity impulse lower, the braking/driving impulse increases in magnitude when a value calculated by adding the driving force to the braking force changes to become larger.

Therefore, when the running vehicle V is subjected to a force from the step S which is external to the vehicle V, the velocity impulse and the braking/driving impulse come to be different from each other in magnitude. That is, when the vehicle V is influenced by disturbance, the velocity impulse comes to deviate from the braking/driving impulse in magnitude. In other words, the impulse received from disturbance causes the velocity impulse to deviate from the braking/driving impulse in magnitude.

Further, as described above, the velocity impulse is 0 in a state in which the vehicle Vis stationary. Therefore, when starting the vehicle V from a state in which the wheel of the vehicle V has collided with the step S, the velocity impulse is 0 until the vehicle V begins running, even when increasing the driving force in order to start the vehicle V. On the other hand, the braking/driving impulse increases in magnitude from 0 even in a state in which the vehicle Vis stationary, by increasing the driving force in order to start the vehicle V.

Therefore, when starting the vehicle V from a state in which the wheel has collided with the step S, the velocity impulse and the braking/driving impulse come to be different from each other in magnitude. That is, when the vehicle V is subjected to a force from the step S which is external to the vehicle V, the braking/driving impulse comes to deviate from the velocity impulse in magnitude. In other words, the impulse received from disturbance causes the velocity impulse to deviate from the braking/driving impulse in magnitude. Hereinafter, the impulse received from the step S which becomes a factor for disturbance when the wheel of the vehicle V running on the road surface collides with the step S and when the vehicle V is started from a state in which the wheel has collided with the step S is defined as a disturbance impulse. The disturbance impulse is calculated by subtracting the braking/driving impulse from the velocity impulse, as shown in equation 3 shown below.

Disturbance impulse=velocity impulse−braking/driving impulse (3)

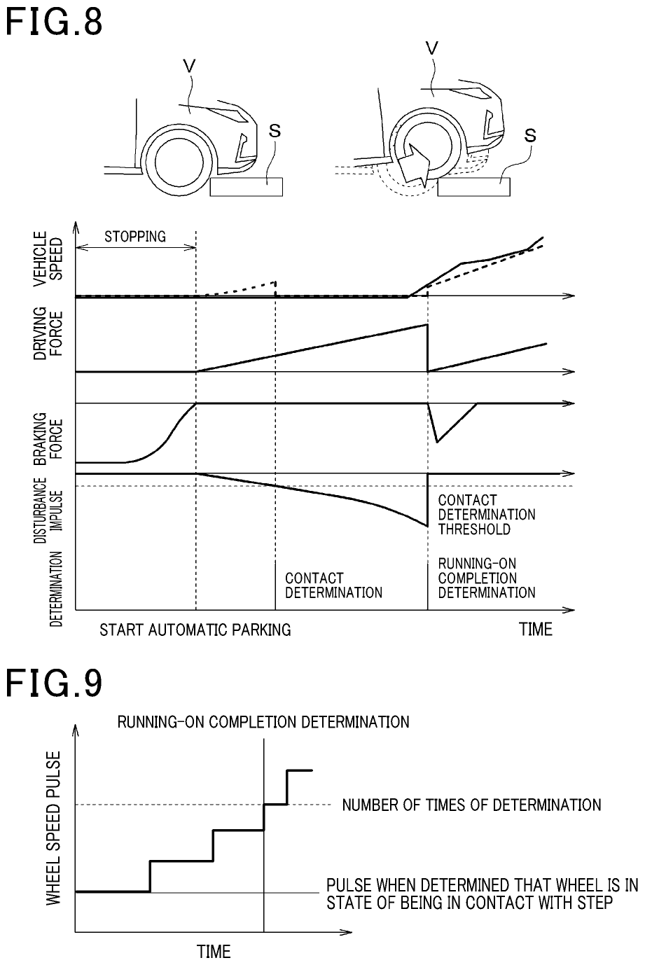

Therefore, in the automatic parking control device 40 of the present embodiment, the impulse calculation unit 43 calculates the velocity impulse and the braking/driving impulse, and the step determination unit 44 determines, based on the velocity impulse and the braking/driving impulse calculated by the impulse calculation unit 43, the collision with the step S and the state of being in contact with the step S. The determination method for the collision of the wheel with the step S and whether the wheel before starting is in a state of being in contact with the step S will be described with reference to FIG. 3, FIG. 8, and FIG. 9.

In step S12, the impulse calculation unit 43 calculates the velocity impulse and the braking/driving impulse acting on the vehicle V when passing over the step S, based on various pieces of information acquired from the sensor unit 30. Specifically, the impulse calculation unit 43 differentiates the detection value detected by the speed sensor 31 to calculate the acceleration of the vehicle V, and calculates the velocity impulse based on the calculated acceleration of the vehicle V and a previously set weight of the vehicle V. Further, the impulse calculation unit 43 calculates the braking/driving impulse based on the output torque of the motor for running detected by the torque sensor 34 and the braking force occurring in the braking system 60 detected by the brake sensor 35. The impulse calculation unit 43 transmits information of the calculated velocity impulse and information of the braking/driving impulse to the step determination unit 44 and the braking/driving calculation unit 422.

In the following step S14, the step determination unit 44 determines whether the vehicle V is running, based on the information acquired from the sensor unit 30. For example, the step determination unit 44 determines that the vehicle V is running when the detection value detected by the speed sensor 31 is not 0, and does not determine that the vehicle V is running when the detection value detected by the speed sensor 31 is 0. The step determination unit 44 executes the process of step S16 in response to not determining that the vehicle V is running and executes the process of step S32 in response to determining that the vehicle V is running.

In step S16, the step determination unit 44 determines whether the wheel of the vehicle V before starting is in a state of being in contact with the step S, based on information of the velocity impulse and information of the braking/driving impulse received from the impulse calculation unit 43. Specifically, the step determination unit 44 calculates, based on information of the velocity impulse and information of the braking/driving impulse, the disturbance impulse that is a difference between the velocity impulse and the braking/driving impulse, and determines whether the wheel of the vehicle V before starting is in a state of being in contact with the step S based on the calculated disturbance impulse. Then, in response to determining that the wheel of the vehicle V before starting is in a state of being in contact with the step S, the automatic parking control device 40 executes the process of step S18 and later.

Further, when it is determined that the vehicle V is running, the step determination unit 44 determines in step S32 whether the wheel of the running vehicle V has collided with the step S based on information of the velocity impulse and information of the braking/driving impulse received from the impulse calculation unit 43. Specifically, the step determination unit 44 calculates, based on information of the velocity impulse and information of the braking/driving impulse, the disturbance impulse that is the difference between the velocity impulse and the braking/driving impulse, and determines whether the wheel of the running vehicle V has collided with the step S based on the calculated disturbance impulse. Then, when it is determined that the wheel of the running vehicle V has collided with the step S, the automatic parking control device 40 executes the process of step S34 and later.

A method in which the step determination unit 44 determines whether the wheel of the vehicle V before starting is in a state of being in contact with the step S based on the disturbance impulse and a control process when the wheel of the vehicle V before starting was determined to be in a state of being in contact with the step S will be described with reference to FIG. 8.

As shown in FIG. 8, when the vehicle V is in a state of stationary before starting, the vehicle speed and the driving force are 0. Further, when the vehicle V is in a state of stationary before starting, the braking system 60 outputs the braking force for stopping the vehicle V.

Then, for example, when the automatic parking control device 40 executes the process of the automatic parking action in response to the start signal of automatic parking being input, the automatic parking is started based on various set values calculated by the braking/driving calculation unit 422. For example, the target speed is set such that the vehicle speed gradually rises with the passage of time. Further, the set value of the driving force is set so as to gradually rise with the passage of time in order to bring the vehicle speed closer to the target speed. Accordingly, the running system outputs the driving force. Note that of the vehicle speed shown in FIG. 8, the broken line indicates the target speed, and the solid line indicates the speed of the vehicle V detected by the speed sensor 31. Further, the set value of the braking force is set to 0. Accordingly, the braking system 60 terminates the output of the braking force.

Here, as shown in FIG. 8, it is assumed that the wheel of the vehicle V before starting is in contact with the step S, and start of the vehicle Vis obstructed by the step S, so that the vehicle V cannot start because of the step S which becomes a factor for disturbance even when the motor for running outputs the driving force. In this case, the vehicle speed maintains 0 immediately after the motor for running has output the driving force. Therefore, the velocity impulse maintains 0 in a state in which start of the vehicle Vis obstructed by the step S.

Further, when start of the vehicle Vis obstructed by the step S, the vehicle speed detected by the speed sensor 31 and the target speed deviate from each other. Then, the deviation amount between the vehicle speed detected by the speed sensor 31 and the target speed gradually increases with the passage of time. Therefore, the braking/driving calculation unit 422 gradually increases the set value of the driving force with the passage of time. Accordingly, the driving force output by the driving system 50 gradually increases with the passage of time. Then, the braking/driving impulse increases with the passage of time.

Therefore, the disturbance impulse calculated by subtracting the braking/driving impulse from the velocity impulse decreases in such a manner as to depart from 0 with the passage of time, as shown in FIG. 8. That is, the absolute value of the disturbance impulse increases with the passage of time.

Here, the step determination unit 44 determines, in step S16, that the wheel of the vehicle V before starting is in a state of being in contact with the step S when the disturbance impulse becomes not more than a previously set contact determination threshold. In other words, the step determination unit 44 determines that the wheel of the vehicle V before starting is in a state of being in contact with the step S when the absolute value of the difference between the velocity impulse and the braking/driving impulse becomes equal to or greater than the contact determination threshold.

The contact determination threshold is a predetermined threshold previously set in order to determine whether the vehicle Vis in a state of being in contact with the step S, and is set based on, for example, an experimental result obtained by previously performing an experiment of starting the vehicle V in a state in which the step S is brought into contact with the wheel. Further, the contact determination threshold is set, in step S16, depending on the height of the step S with which contact is desired to be detected.

In this manner, the vehicle control device 1 of the present embodiment can accurately detect that the wheel of the vehicle V before starting is in contact with the step S by determining that the wheel of the vehicle V before starting is in a state of being in contact with the step S based on the disturbance impulse. Then, it can be detected that the vehicle V has started from a state in which the wheel is in contact with the step S.

Further, the contact determination threshold of the present embodiment is set so as to be changeable depending on the roughness of the road surface. For example, in the step determination unit 44, a base threshold to serve as a reference threshold is previously defined, and a predetermined additional value is added to the base threshold depending on the roughness of the road surface such that the contact determination threshold is changeable. The base threshold is set depending on, for example, the height of the step S.

Then, the contact determination threshold is set so as to be changeable depending on the roughness of the road surface between a good road threshold in which the predetermined additional value is added when the roughness of the road surface is flat and a bad road threshold in which the predetermined additional value is added when the roughness of the road surface is rougher than flatness and has an uneven shape. The predetermined additional value added when setting the good road threshold is set to be smaller than the predetermined additional value added when setting the bad road threshold. That is, the good road threshold is smaller than the bad road threshold. The step determination unit 44 detects the roughness of the road surface, and sets the contact determination threshold to one of the good road threshold and the bad road threshold.

The step determination unit 44 may detect the roughness of the road surface, for example, based on the speed of the vehicle V detected by the speed sensor 31 when finally having run, before the vehicle V terminates running. For example, when a deviation between the speed of the vehicle V detected by the speed sensor 31 when finally having run and the target speed when finally having run is relatively small, the step determination unit 44 determines that the roughness of the road surface is flat and sets the contact determination threshold to the good road threshold. On the other hand, for example, when the deviation between the speed of the vehicle V detected by the speed sensor 31 when finally having run and the target speed when finally having run is relatively large, the step determination unit 44 determines that the roughness of the road surface has an uneven shape, and sets the contact determination threshold to the bad road threshold which is larger than the good road threshold.

A reason why the roughness of the road surface can be determined based on the deviation between the speed of the vehicle V detected by the speed sensor 31 and the target speed in this manner is that resistance received from the road surface when the vehicle V runs on the road surface is reduced when the road surface is flat compared to when the road surface has an uneven shape. That is, it is because when the resistance received from the road surface is small, the speed of the vehicle V can be easily brought closer to the target speed.

Note that the step determination unit 44 may detect the roughness of the road surface based on information other than the speed of the vehicle V detected by the speed sensor 31. For example, the step determination unit 44 may detect the roughness of the road surface based on the acceleration in the upper and lower direction of the vehicle V detected by the acceleration sensor 32. In this case, for example, when the acceleration in the upper and lower direction of the vehicle V detected by the acceleration sensor 32 when finally having run is a predetermined value or less, the step determination unit 44 may determine that the roughness of the road surface is flat and set the contact determination threshold to the good road threshold. On the other hand, for example, when the acceleration in the upper and lower direction of the vehicle V detected by the acceleration sensor 32 when finally having run is larger than the predetermined value, the step determination unit 44 determines that the roughness of the road surface has an uneven shape, and sets the contact determination threshold to the bad road threshold.

Further, the step determination unit 44 may detect the roughness of the road surface based on the image of the road surface taken by the camera of the surroundings monitoring unit 10 or based on reflected waves from the road surface acquired by each of the sonar, the millimeter-wave radar, and the LIDAR of the surroundings monitoring unit 10.

In response to determining in step S16 that the wheel of the vehicle V before starting is in a state of being in contact with the step S, the step determination unit 44 transmits information of the determination result to the braking/driving calculation unit 422. In response to receiving information that the wheel of the vehicle V before starting is in a state of being in contact with the step S from the step determination unit 44, the braking/driving calculation unit 422 executes the process of step S18.

In step S18, the braking/driving calculation unit 422 calculates the driving force necessary for passing over the step S based on the determination result of the step determination unit 44. For example, the braking/driving calculation unit 422 calculates, as the driving force necessary for passing over the step S, a value calculated by increasing the set value set in step S120 of the previous control period in the automatic parking action by a previously set increase amount.

Then, in step S20, the braking/driving calculation unit 422 transmits information of the calculated driving force necessary for passing over the step S to the driving ECU 51 of the driving system 50.

Accordingly, the driving force output by the motor for running becomes larger than the set value set in response to the start signal of automatic parking being input.

In the following step S22, the step determination unit 44 detects the quantity of pulse signals based on pulse signals output by the speed sensor 31. The step determination unit 44 detects the quantity of pulse signals received from the speed sensor 31 after it was determined in step S16 that the wheel is in a state of being in contact with the step S. Then, the step determination unit 44 determines whether the wheel of the vehicle V has run on the step S, based on whether the quantity of pulse signals received is equal to or greater than the number of times of determination previously set.

A reason why it can be determined whether the wheel has run on the step S based on the quantity of received pulse signals will be described with reference to FIG. 9.

As described above, the speed sensor 31 outputs pulse signals shown in FIG. 9 the designed number of times depending on the revolution angle of the wheel every time the wheel revolves once. Therefore, the revolution angle of the wheel is calculated based on the number of pulse signals. Then, a proceeding distance of the vehicle V is calculated based on the revolution angle of the wheel. Therefore, the step determination unit 44 can determine whether the vehicle V has proceeded and has run on the step S based on the quantity of detected pulse signals. Note that the pulse width of the pulse signal decreases as the revolution speed of the wheel is faster.

In the present embodiment, the number of times of determination for determining whether the wheel of the vehicle V has run on the step S is set to 3. Therefore, the step determination unit 44 determines that the wheel has run on the step S when the pulse signal received from the speed sensor 31 after it was determined that the wheel is in a state of being in contact with the step S is received three times. Note that the number of times of determination for determining whether the wheel of the vehicle V has run on the step S is not limited to 3, and may be less than 3 or more than 3. The more the number of times of determination, the longer a time until it is determined that the wheel has run on the step S when the wheel has revolved, but an erroneous determination attributable to a spin of the wheel can be prevented.

Further, in the present embodiment, it is determined whether the wheel has run on the step S, based on the quantity of pulse signals received from the speed sensor 31 provided to each of the four wheels. For example, the step determination unit 44 may determine that the wheel has run on the step S when the pulse signal was received the number of times of determination from two of the four speed sensors 31. Alternatively, the step determination unit 44 may determine that the wheel has run on the step S when the pulse signal was received the number of times of determination from all of the four speed sensors 31.

The automatic parking control device 40 repeatedly executes the process of step S18 to step S24 until it is determined that the wheel of the vehicle V has run on the step S. Then, in response to determining in step S24 that the wheel of the vehicle V has run on the step S, the step determination unit 44 transmits information of the determination result to the braking/driving calculation unit 422. In response to receiving from the step determination unit 44 information that the wheel has run on the step S, the braking/driving calculation unit 422 executes the process of step S26.

In this manner, the vehicle control device 1 of the present embodiment can accurately detect that the wheel has run on the step S by determining that the wheel of the vehicle V having been in contact with the step S before starting has run on the step S based on the number of pulse signals received from the speed sensor 31.

In step S26, the braking/driving calculation unit 422 calculates the driving force immediately after having run on the step S and the braking force immediately after having run on the step S, based on the determination result of the step determination unit 44 as well as information of the velocity impulse and information of the braking/driving impulse calculated by the impulse calculation unit 43. For example, the braking/driving calculation unit 422 calculates, as the driving force immediately after having run on the step S, a value calculated by reducing the driving force set in step S18 for passing over the step S by a previously set decrease amount. In the present embodiment, the braking/driving calculation unit 422 sets the set value of the driving force immediately after having run on the step S to 0.

By the way, when the braking force immediately after having run on the step S calculated in step S26 or the decrease amount of the driving force is insufficient for the driving force calculated in step S18 for passing over the step S, the vehicle speed may abruptly rise after having passed over the step S. Further, when the braking force immediately after having run on the step S calculated in step S26 is excessive for the driving force calculated in step S18 for passing over the step S, the vehicle V may decelerate more than necessary after having passed over the step S. Therefore, in the vehicle control device 1 of the present embodiment, the braking/driving calculation unit 422 appropriately calculates the braking force and the driving force immediately after having passed over the step S such that the braking force and the driving force after having passed over the step S are not excessive or insufficient.

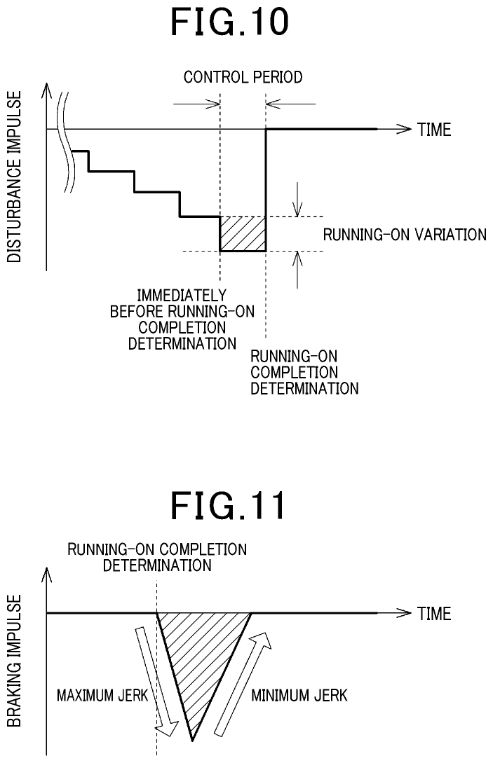

A calculation method when the braking/driving calculation unit 422 sets the braking force and the driving force will be described with reference to FIG. 10 and FIG. 11.

As described above, the automatic parking control device 40 increases the driving force by a previously set increase amount every control period by repeatedly executing the process of step S18 to step S24 until it is determined that the wheel of the vehicle V has run on the step S. Accordingly, the disturbance impulse calculated by subtracting the braking/driving impulse from the velocity impulse decreases in such a manner as to depart from 0 with the passage of time, as shown in FIG. 10. Specifically, the disturbance impulse decreases stepwise with the passage of time such that the absolute value thereof increases.

Here, in a state in which the vehicle V stops before running on the step S, the larger the braking/driving impulse, the larger the absolute value of the disturbance impulse calculated by subtracting the braking/driving impulse from the velocity impulse. Then, in the present embodiment, the set value of the braking force when executing the automatic parking process is set to 0 as described above. Therefore, the disturbance impulse which decreases such that the absolute value increases stepwise changes every control period depending on the variation of the driving force which increases by a previously set increase amount.

By the way, when the driving force increases by a previously set increase amount and becomes equal to or greater than the driving force necessary for passing over the step S, the wheel of the vehicle V runs on the step S, and the step determination unit 44 therefore determines that the wheel has run on the step S. Therefore, the disturbance impulse calculated when it was determined that the wheel of the vehicle V has run on the step S is a disturbance impulse immediately after the vehicle V has run on the step S. On the other hand, the disturbance impulse calculated in the control period immediately before a timing at which it was determined that the wheel of the vehicle V has run on the step S is a disturbance impulse immediately before the vehicle V runs on the step S.

Then, the disturbance impulse calculated when it was determined that the wheel of the vehicle V has run on the step S is a disturbance impulse when the driving force calculated by the braking/driving calculation unit 422 has become equal to or greater than the driving force necessary for passing over the step S. Further, the disturbance impulse calculated in the control period immediately before a timing at which it was determined that the wheel of the vehicle V has run on the step S is a disturbance impulse immediately before a timing at which the driving force calculated by the braking/driving calculation unit 422 becomes equal to or greater than the driving force necessary for passing over the step S.

Further, a difference between the disturbance impulse calculated when it was determined that the wheel of the vehicle V has run on the step S and the disturbance impulse calculated immediately before a timing at which it was determined that the wheel of the vehicle V has run on the step S is the variation of the disturbance impulse which decreases every control period. This difference between the disturbance impulse when it was determined that the wheel has run on the step S and the disturbance impulse immediately before a timing at which it was determined that the wheel has run on the step S is the variation of the impulse received from the step S which becomes disturbance when the vehicle V has run on the step S. Then, the difference in disturbance impulse is an excess disturbance impulse component which becomes a factor for abruptly rising the vehicle speed of the vehicle V when the vehicle V has run on the step S.

Therefore, the braking force and the driving force after having run on the step S are required to be set based on the difference between the disturbance impulse when it was determined that the wheel has run on the step S and the disturbance impulse immediately before a timing at which it was determined that the vehicle V has run on the step S. Hereinafter, the difference between the disturbance impulse calculated when it was determined that the wheel of the vehicle V has run on the step S and the disturbance impulse calculated immediately before a timing at which it was determined that the wheel of the vehicle V has run on the step S is called a running-on variation.

The braking/driving calculation unit 422 calculates the braking force and the driving force immediately after the wheel of the vehicle V has run on the step S based on the running-on variation. In other words, the braking/driving calculation unit 422 calculates the braking force and the driving force immediately after the vehicle V has passed over the step S based on the variation of the disturbance impulse when passing over the step S.

Specifically, the braking/driving calculation unit 422 of the present embodiment brings the set value of the driving force immediately after having run on the step S closer to 0 possible in order to prevent the vehicle V from abruptly accelerating immediately after the wheel has run on the step S.

Further, in order to prevent the vehicle V from abruptly accelerating immediately after the wheel has run on the step S, the braking/driving calculation unit 422 increases the set value of the braking force immediately after having run on the step S from 0 and thereafter decreases the braking force to 0 such that the vehicle speed approaches the target speed. Therefore, as shown in FIG. 11, the braking/driving impulse based on the braking force and the driving force set by the braking/driving calculation unit 422 gradually increases with an increase of the braking force from immediately after it was determined that the wheel has run on the step S, and thereafter gradually decreases with a decrease of the braking force.

The braking/driving calculation unit 422 of the present embodiment calculates the braking force immediately after having run on the step S such that a difference between the absolute value of the braking/driving impulse immediately after having run on the step S and the absolute value of the running-on variation approaches 0. Specifically, the braking/driving calculation unit 422 calculates the braking force immediately after having run on the step S such that the absolute value of the braking/driving impulse immediately after having run on the step S is equal to the absolute value of the running-on variation.

Here, the absolute value of the braking/driving impulse immediately after having run on the step S is a braking/driving impulse component shown by slanted hatching shown in FIG. 11. Further, the running-on variation that is the difference between the disturbance impulse calculated when it was determined that the wheel of the vehicle V has run on the step S and the disturbance impulse calculated immediately before a timing at which it was determined that the wheel of the vehicle V has run on the step S is a disturbance impulse component shown by slanted hatching shown in FIG. 10. The braking/driving calculation unit 422 of the present embodiment sets the braking force immediately after having run on the step S such that an area of a portion shown by slanted hatching of the disturbance impulse shown in FIG. 10 is equal to an area of a portion shown in slanted hatching of the braking/driving impulse shown in FIG. 11.

By the way, in order to prevent the vehicle V from abruptly accelerating immediately after the wheel has run on the step S, it is desirable to change the braking force to a necessary magnitude as rapidly as possible. Further, after the braking force was increased to the necessary magnitude, it is desirable to change the braking force from the braking force set for preventing abrupt acceleration to 0 as rapidly as possible, in order to bring the vehicle speed closer to the target speed. Therefore, the braking/driving calculation unit 422 transmits information of the calculated braking force to the braking system 60 and rapidly changes the braking force such that the braking force output by the braking system 60 becomes the calculated set value.

However, the maximum value of a variation of an acceleration per unit time of the vehicle V which is changeable by the braking force output by the braking system 60 is previously limited by the performance of the braking system 60. In other words, the jerk of the vehicle V which decreases by increasing the braking force and the jerk of the vehicle V which increases by decreasing the braking force are limited by the performance of the braking system 60. For example, it is difficult to momentarily change the braking force to the necessary magnitude immediately after the wheel has run on the step S. Further, it is difficult to momentarily bring the braking force to 0 after having changed the braking force to the necessary magnitude.

Here, the maximum value of the acceleration per unit time of the vehicle V which is decreased by increasing the braking force output by the braking system 60 is defined as a maximum jerk. Further, the minimum value of the acceleration per unit time of the vehicle V which is increased by decreasing the braking force output by the braking system 60 is defined as a minimum jerk. The maximum jerk and the minimum jerk are previously determined by, for example, properties of an unshown actuator of the braking system 60 that adjusts the brake fluid pressure.

When decelerating the vehicle V by increasing the braking force immediately after having run on the step S, the braking/driving calculation unit 422 of the present embodiment sets the braking force such that the decrease amount of the acceleration per unit time of the vehicle V becomes the maximum jerk. Further, when accelerating the vehicle V after decelerating the vehicle V immediately after having run on the step S, the braking/driving calculation unit 422 sets the braking force such that the increase amount of the acceleration per unit time of the vehicle V becomes the minimum jerk.

Returning to FIG. 3, in step S28, the braking/driving calculation unit 422 transmits information of the calculated driving force immediately after having run on the step S to the driving ECU 51 of the driving system 50, and transmits information of the calculated braking force immediately after having run on the step S to the braking ECU 61 of the braking system 60.

Accordingly, the driving force output by the driving system 50 becomes smaller than the set value set in step S18. Specifically, the driving force output by the driving system 50 immediately after having run on the step S becomes 0, as shown in FIG. 8.

Further, the braking force output by the braking system 60 becomes larger than the set value set in step S18. Specifically, the driving force output by the braking system 60 immediately after having run on the step S gradually increases with the passage of time, as shown in FIG. 8. By controlling the driving force and the braking force after having run on the step S in this manner, abrupt acceleration of the vehicle V after the vehicle V has run on the step S can be suppressed.

Then, in step S30, the automatic parking control device 40 controls the vehicle V for a previously determined time by the driving force and the braking force set in step S26 and thereafter returns to the control before it is determined that the wheel of the vehicle V before starting is in contact with the step S. That is, the automatic parking control device 40 performs the process of step S100 to step S140 and performs the automatic parking action.

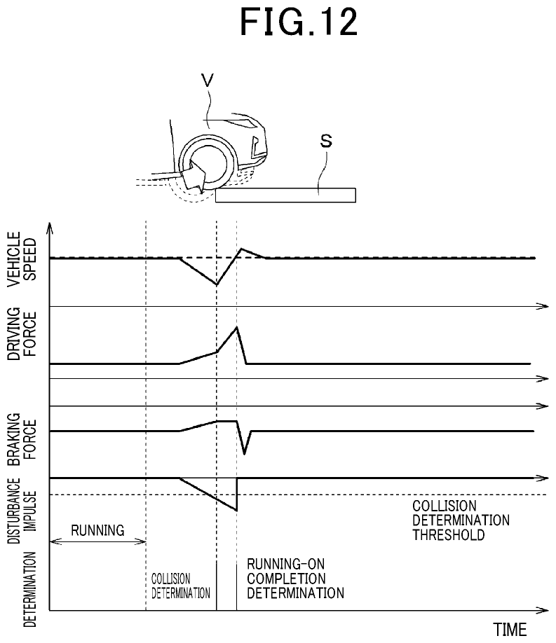

Subsequently, a method in which the step determination unit 44 determines whether the wheel of the running vehicle V has collided with the step S based on the disturbance impulse and a control process when it was determined that the wheel of the running vehicle V has collided with the step S will be described with reference to FIG. 12.

When the target speed is set, in the process of the automatic parking action, such that the vehicle V runs at a constant speed, the driving force output by the driving system 50 and the braking force output by the braking system 60 become constant, as shown in FIG. 12. In this case, the velocity impulse and the braking/driving impulse maintain 0. Here, as shown in FIG. 12, in response to the wheel of the running vehicle V colliding with the step S, the vehicle speed lowers than the target speed. Note that of the vehicle speed shown in FIG. 12, the broken line indicates the target speed, and the solid line indicates the speed of the vehicle V detected by the speed sensor 31.

Accordingly, the vehicle speed detected by the speed sensor 31 and the target speed deviate from each other. Then, the deviation amount between the vehicle speed detected by the speed sensor 31 and the target speed gradually increases with the passage of time. Further, the velocity impulse lowers in magnitude with lowering of the vehicle speed.

Then, the braking/driving calculation unit 422 gradually increases the set value of the driving force and gradually decreases the set value of the braking force with the passage of time, when the vehicle speed detected by the speed sensor 31 and the target speed deviate from each other. Accordingly, the driving force output by the driving system 50 gradually increases with the passage of time. Further, the braking force output by the braking system 60 gradually increases with the passage of time. Accordingly, the braking/driving impulse increases with the passage of time.

Therefore, the disturbance impulse calculated by subtracting the braking/driving impulse from the velocity impulse decreases with the passage of time in such a manner as to depart from 0, as shown in FIG. 1012. That is, the absolute value of the disturbance impulse increases with the passage of time.

Here, the step determination unit 44 determines, in step S32, that the wheel of the running vehicle V has collided with the step S when the disturbance impulse becomes not more than a previously set collision determination threshold. In other words, the step determination unit 44 determines that the wheel of the running vehicle V has collided with the step S when the absolute value of the difference between the velocity impulse and the braking/driving impulse becomes equal to or greater than the collision determination threshold.

The collision determination threshold is a predetermined threshold previously set for determining whether the wheel of the running vehicle V has collided with the step S, and is set based on, for example, an experimental result obtained by previously performing an experiment in which the wheel of the running vehicle V is collided with the step S. Further, the collision determination threshold is set, in step S32, depending on the height of the step S which it is desired to be detected that the wheel of the running vehicle V has collided with the step S. Note that the collision determination threshold may be set to be the same as the contact determination threshold in magnitude, or may be set to be different from the contact determination threshold in magnitude.

In this manner, the vehicle control device 1 of the present embodiment can accurately detect that the wheel has collided with the step S by determining that the wheel of the running vehicle V has collided with the step S based on the disturbance impulse.

Further, the collision determination threshold of the present embodiment is, similarly to the contact determination threshold, set to be changeable depending on the roughness of the road surface. Specifically, in the step determination unit 44, similarly to the contact determination threshold, a base threshold to serve as a reference threshold is previously defined, and a predetermined additional value is added to the base threshold depending on the roughness of the road surface so that the collision determination threshold is changeable. The step determination unit 44 detects the roughness of the road surface, and sets the collision determination threshold to one of the good road threshold and the bad road threshold. The base threshold is set depending on, for example, the height of the step S.

For example, when a deviation between the speed of the vehicle V detected by the speed sensor 31 when having accelerated the vehicle V and the target speed when finally having run is relatively small, the step determination unit 44 determines that the roughness of the road surface is flat and sets the collision determination threshold to the good road threshold. On the other hand, for example, when the deviation between the speed of the vehicle V detected by the speed sensor 31 when having accelerated the vehicle V and the target speed when finally having run is relatively large, the step determination unit 44 determines that the roughness of the road surface has an uneven shape, and sets the collision determination threshold to the bad road threshold.

Note that the step determination unit 44 may detect the roughness of the road surface based on the acceleration in the upper and lower direction of the vehicle V detected by the acceleration sensor 32 while the vehicle Vis running, and set the collision determination threshold to one of the good road threshold and the bad road threshold based on the detected roughness of the road surface.

Further, the step determination unit 44 may detect the roughness of the road surface based on the image of the road surface taken by the camera of the surroundings monitoring unit 10 while the vehicle V is running, and set the collision determination threshold to one of the good road threshold and the bad road threshold based on the detected roughness of the road surface. Alternatively, the step determination unit 44 may detect the roughness of the road surface based on reflected waves from the road surface acquired by each of the sonar, the millimeter-wave radar, and the LIDAR of the surroundings monitoring unit 10, and set the collision determination threshold to one of the good road threshold and the bad road threshold based on the detected roughness of the road surface.

In response to determining in step S32 that the wheel of the running vehicle V has collided with the step S, the step determination unit 44 transmits information of the determination result to the braking/driving calculation unit 422. In response to receiving from the step determination unit 44 information that the wheel of the running vehicle V has collided with the step S, the braking/driving calculation unit 422 executes the process of step S34.

In step S34, the braking/driving calculation unit 422 calculates the driving force necessary for passing over the step S based on the determination result of the step determination unit 44. For example, the braking/driving calculation unit 422 calculates, as the driving force necessary for passing over the step S, a value calculated by increasing the set value set in step S120 of the previous control period in the automatic parking action by a previously set increase amount.

Then, in step S36, the braking/driving calculation unit 422 transmits information of the calculated driving force necessary for passing over the step S to the driving ECU 51 of the driving system 50.

Accordingly, the driving force output by the motor for running becomes larger than the set value set in step S120 of the previous control period in the automatic parking action. With an increase of the driving force output by the motor for running, the wheel of the vehicle V begins running on the step S, and the vehicle speed rises so as to approach the target speed. Accordingly, the vehicle speed detected by the speed sensor 31 can be brought closer to the target speed. Then, the deviation amount between the vehicle speed detected by the speed sensor 31 and the target speed gradually decreases with the passage of time. Further, the velocity impulse rises in magnitude with a rise of the vehicle speed.

Further, the braking/driving calculation unit 422 sets the set value of the driving force output by the motor for running to be larger than the set value of the driving force set before it is determined that the wheel of the running vehicle V has collided with the step S. Accordingly, the braking/driving impulse increases with the passage of time.

Therefore, the disturbance impulse calculated by subtracting the braking/driving impulse from the velocity impulse increases in such a manner as to approach 0 with the passage of time, as shown in FIG. 1012. That is, the absolute value of the disturbance impulse decreases with the passage of time.

In the following step S38, the impulse calculation unit 43 calculates the velocity impulse and the braking/driving impulse acting on the vehicle V when passing over the step S, based on various pieces of information acquired from the sensor unit 30. Specifically, the impulse calculation unit 43 differentiates the detection value detected by the speed sensor 31 to calculate the acceleration of the vehicle V, and calculates the velocity impulse based on the calculated acceleration of the vehicle V and a previously set weight of the vehicle V. Further, the impulse calculation unit 43 calculates the braking/driving impulse based on the output torque of the motor for running detected by the torque sensor 34 and the braking force occurring in the braking system 60 detected by the brake sensor 35. The impulse calculation unit 43 transmits information of the calculated velocity impulse and information of the calculated braking/driving impulse to the step determination unit 44.

In the following step S40, the step determination unit 44 determines whether the wheel of the vehicle V has run on the step S, based on information of the velocity impulse and information of the braking/driving impulse received from the impulse calculation unit 43. Specifically, the step determination unit 44 calculates the braking/driving impulse after it was determined that the wheel has collided with the step S and the disturbance impulse after it was determined that the wheel has collided with the step S, based on information of the braking/driving impulse calculated by the impulse calculation unit 43. Then, the step determination unit 44 determines that the wheel of the vehicle V has run on the step S, when the braking/driving impulse after it was determined that the wheel has collided with the step S became equal to or greater than the disturbance impulse after it was determined that the wheel has collided with the step S.

The automatic parking control device 40 repeatedly executes the process of step S34 to step S40 until it is determined that the wheel of the vehicle V has run on the step S. Then, in response to determining in step S40 that the wheel of the vehicle V has run on the step S, the step determination unit 44 transmits information of the determination result to the braking/driving calculation unit 422. In response to receiving from the step determination unit 44 information that the wheel has run on the step S, the braking/driving calculation unit 422 executes the process of step S42.

In this manner, the vehicle control device 1 of the present embodiment can accurately detect that the wheel has run on the step S by determining that the wheel has run on the step S after the wheel of the running vehicle V collided with the step S based on the velocity impulse and the braking/driving impulse calculated by the impulse calculation unit 43.

In step S42, the braking/driving calculation unit 422 calculates the driving force immediately after having run on the step S and the braking force immediately after having run on the step S, based on the determination result of the step determination unit 44 as well as information of the velocity impulse and information of the braking/driving impulse calculated by the impulse calculation unit 43.

By the way, similarly to when the wheel of the vehicle V has collided with the step S before starting, when the braking force immediately after having run on the step S or the decrease amount of the driving force is insufficient for the driving force calculated in step S34, the vehicle speed may abruptly rise after having passed over the step S. Further, when the braking force immediately after having run on the step S is excessive for the driving force calculated in step S34 for passing over the step S, the vehicle V may decelerate more than necessary after having passed over the step S. Therefore, in the vehicle control device 1 of the present embodiment, the braking/driving calculation unit 422 appropriately sets the braking force and the driving force immediately after having passed over the step S, using a calculation method similar to that when the wheel of the vehicle V has collided with the step S before starting.

Specifically, the braking/driving calculation unit 422 sets the set value of the driving force immediately after having run on the step S to be the same as the set value of the driving force before increased by the wheel of the vehicle V colliding with the step S, in order to prevent the vehicle V from abruptly accelerating immediately after the wheel has run on the step S.

Further, the braking/driving calculation unit 422 sets the set value of the braking force immediately after having run on the step S to be large, in order to prevent the vehicle V from abruptly accelerating immediately after the wheel has run on the step S. Thereafter, the braking/driving calculation unit 422 sets the set value of the braking force to be the same as the set value of the braking force before decreased when the wheel collides with the step S, such that the vehicle speed approaches the target speed. Therefore, the braking/driving impulse based on the braking force and the driving force set by the braking/driving calculation unit 422 gradually increases from immediately after it was determined that the wheel has run on the step S and thereafter gradually decreases, as shown in FIG. 11.

The braking/driving calculation unit 422 of the present embodiment calculates the braking force immediately after having run on the step S such that a difference between the absolute value of the braking/driving impulse immediately after having run on the step S and the absolute value of the running-on variation approaches 0. Specifically, the braking/driving calculation unit 422 calculates the braking force immediately after having run on the step S such that the absolute value of the braking/driving impulse immediately after having run on the step S is equal to the absolute value of the running-on variation.

Further, when decelerating the vehicle V by increasing the braking force immediately after having run on the step S, the braking/driving calculation unit 422 sets the braking force such that the decrease amount of the acceleration per unit time of the vehicle V becomes the maximum jerk. Further, when accelerating the vehicle V after decelerating the vehicle V immediately after having run on the step S, the braking/driving calculation unit 422 sets the braking force such that the increase amount of the acceleration per unit time of the vehicle V becomes the minimum jerk.

Then, in step S44, the braking/driving calculation unit 422 transmits information of the calculated driving force immediately after having run on the step S to the driving ECU 51 of the driving system 50, and transmits information of the calculated braking force immediately after having run on the step S to the braking ECU 61 of the braking system 60.

Accordingly, the driving force output by the driving system 50 becomes smaller than the set value set in step S34. Specifically, the driving force output by the driving system 50 immediately after having run on the step S gradually decreases so as to become the driving force immediately before the wheel of the vehicle V collides with the step S, as shown in FIG. 12.

Further, the braking force output by the braking system 60 becomes larger than the set value set in step S34. Specifically, the driving force output by the braking system 60 immediately after having run on the step S gradually increases with the passage of time, as shown in FIG. 12. By controlling the driving force and the braking force immediately after having run on the step S in this manner, abrupt acceleration of the vehicle V after the vehicle V has run on the step S can be suppressed, and the vehicle speed can be returned to the vehicle speed before the wheel of the vehicle V collides with the step S.

Then, the automatic parking control device 40 controls the vehicle V for a previously determined time by the driving force and the braking force set in step S42 and thereafter returns to the control before it is determined that the wheel of the vehicle V has collided with the step S. That is, the automatic parking control device 40 performs the process of step S100 to step S140 and performs the automatic parking action.

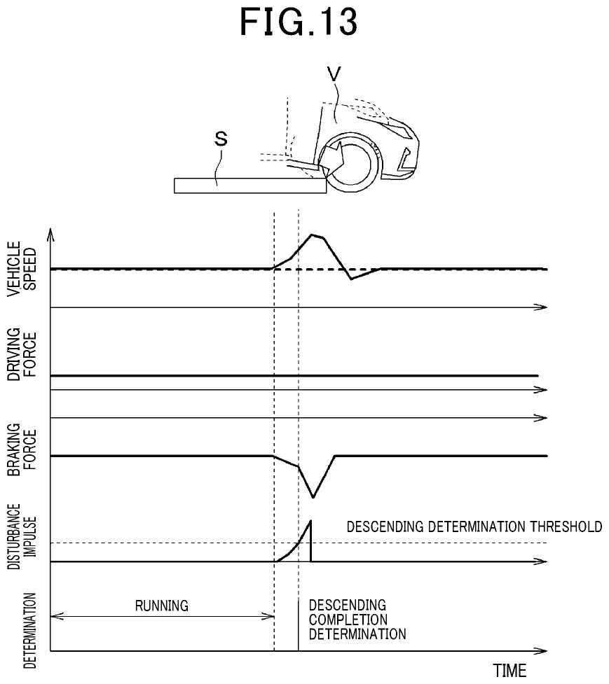

Subsequently, the control process containing the control process executed after the vehicle V has descended from the step S from a state of having run on the step S during the automatic parking action will be described with reference to FIG. 4 and FIG. 13. Note that since the automatic parking process of step S50 shown in FIG. 4 is the same process as the automatic parking process of step S10 shown in FIG. 3, description thereof will be omitted.

As described above, when the vehicle V running on the flat road surface at a constant speed descends from the step S as shown in FIG. 13, potential energy is converted into kinetic energy due to gravity, and the vehicle speed rises. Therefore, in order to prevent the vehicle speed from abruptly rising after the wheel has descended from the step S, the driving force after having descended from the step S needs to be lowered than the driving force set before descending from the step S. Therefore, in order to prevent the vehicle speed from abruptly rising after the wheel has descended from the step S, the braking force after having descended from the step S needs to be increased than the braking force set before descending from the step S.

Therefore, the automatic parking control device 40 of the present embodiment executes the process of step S52 and later during the automatic parking action and detects that the wheel has descended from the step S, in the control process shown in FIG. 4. Then, when the wheel has descended from the step S, the automatic parking control device 40 increases the braking force than before descending from the step S.

Specifically, in the automatic parking control device 40 of the present embodiment, the impulse calculation unit 43 calculates the velocity impulse and the braking/driving impulse, and the step determination unit 44 determines, based on the velocity impulse and the braking/driving impulse calculated by the impulse calculation unit 43, that the wheel has descended from the step S.

When the target speed is set, in the process of the automatic parking action, such that the vehicle V runs at a constant speed, the driving force output by the driving system 50 and the braking force output by the braking system 60 become constant, as shown in FIG. 13. In this case, the velocity impulse and the braking/driving impulse maintain 0. Here, as shown in FIG. 13, in response to the wheel of the running vehicle V descending from the step S, the vehicle speed rises than the target speed. Note that of the vehicle speed shown in FIG. 13, the broken line indicates the target speed, and the solid line indicates the speed of the vehicle V detected by the speed sensor 31.

Accordingly, the vehicle speed detected by the speed sensor 31 and the target speed deviate from each other. Then, the deviation amount between the vehicle speed detected by the speed sensor 31 and the target speed gradually increases with the passage of time. Further, the velocity impulse increases in magnitude with a rise of the vehicle speed.

Then, the braking/driving calculation unit 422 gradually increases the set value of the braking force with the passage of time, when the vehicle speed detected by the speed sensor 31 and the target speed deviate from each other. Accordingly, the braking force output by the braking system 60 gradually increases with the passage of time. Accordingly, the braking/driving impulse increases with the passage of time.

Therefore, the disturbance impulse calculated by subtracting the braking/driving impulse from the velocity impulse increases in such a manner as to depart from 0 with the passage of time, as shown in FIG. 13. That is, the absolute value of the disturbance impulse increases with the passage of time.

Here, the step determination unit 44 determines, in step S54, that the wheel of the running vehicle V has descended from the step S when the disturbance impulse becomes not more than a previously set descending determination threshold. In other words, the step determination unit 44 determines that the wheel of the running vehicle V has descended from the step S when the absolute value of the difference between the velocity impulse and the braking/driving impulse becomes equal to or greater than the descending determination threshold.

The descending determination threshold is a predetermined threshold previously set for determining whether the wheel of the running vehicle V has descended from the step S, and is set based on, for example, an experimental result obtained by previously performing an experiment in which the wheel of the running vehicle V descends from the step S. Further, the descending determination threshold is set, in step S54, depending on the height of the step S which it is desired to be detected that the wheel of the running vehicle V has descended from the step S. Note that the descending determination threshold may be set to be the same as the contact determination threshold and the collision determination threshold in magnitude, or may be set to be different from the contact determination threshold and the collision determination threshold in magnitude.

In this manner, the vehicle control device 1 of the present embodiment can accurately detect that the wheel has descended from the step S by determining that the wheel of the running vehicle V has descended from the step S based on the disturbance impulse.

Further, the descending determination threshold of the present embodiment is, similarly to the contact determination threshold and the collision determination threshold, set to be changeable depending on the roughness of the road surface. Specifically, in the step determination unit 44, similarly to the contact determination threshold and the collision determination threshold, a base threshold to serve as a reference threshold is previously defined, and a predetermined additional value is added to the base threshold depending on the roughness of the road surface so that the descending determination threshold is changeable. The step determination unit 44 detects the roughness of the road surface, and sets the descending determination threshold to one of the good road threshold and the bad road threshold. The base threshold is set depending on, for example, the height of the step S.

For example, when the deviation between the speed of the vehicle V detected by the speed sensor 31 when having accelerated the vehicle V and the target speed when finally having run is relatively small, the step determination unit 44 determines that the roughness of the road surface is flat and sets the descending determination threshold to the good road threshold. On the other hand, for example, when the deviation between the speed of the vehicle V detected by the speed sensor 31 when having accelerated the vehicle V and the target speed when finally having run is relatively large, the step determination unit 44 determines that the roughness of the road surface has an uneven shape, and sets the descending determination threshold to the bad road threshold.

Note that the step determination unit 44 may detect the roughness of the road surface based on the acceleration in the upper and lower direction of the vehicle V detected by the acceleration sensor 32 while the vehicle V is running, and set the descending determination threshold to one of the good road threshold and the bad road threshold based on the detected roughness of the road surface.

Further, the step determination unit 44 may detect the roughness of the road surface based on the image of the road surface taken by the camera of the surroundings monitoring unit 10 while the vehicle V is running, and set the descending determination threshold to one of the good road threshold and the bad road threshold based on the detected roughness of the road surface. Alternatively, the step determination unit 44 may detect the roughness of the road surface based on reflected waves from the road surface acquired by each of the sonar, the millimeter-wave radar, and the LIDAR of the surroundings monitoring unit 10, and set the descending determination threshold to one of the good road threshold and the bad road threshold based on the detected roughness of the road surface.

In response to determining in step S54 that the wheel of the running vehicle V has descended from the step S, the step determination unit 44 transmits information of the determination result to the braking/driving calculation unit 422. In response to receiving, from the step determination unit 44, information that the wheel of the running vehicle V has descended from the step S, the braking/driving calculation unit 422 executes the process of step S56.

In step S56, the braking/driving calculation unit 422 calculates the driving force immediately after having descended from the step S and the braking force immediately after having descended from the step S, based on the determination result of the step determination unit 44 as well as information of the velocity impulse and information of the braking/driving impulse calculated by the impulse calculation unit 43.

By the way, similarly to when the wheel of the vehicle V has run on the step S, when the braking force immediately after having descended from the step S calculated in step S56 or the decrease amount of the driving force is insufficient for the driving force calculated in step S50, the vehicle speed may abruptly rise after having descended from the step S. Further, when the braking force immediately after having descending from the step S calculated in step S56 is excessive for the driving force calculated in step S50, the vehicle V may decelerate more than necessary after having descended from the step S. Therefore, in the vehicle control device 1 of the present embodiment, the braking/driving calculation unit 422 appropriately sets the braking force and the driving force immediately after having descended from the step S such that the braking force and the driving force after having descended from the step S are not excessive or insufficient.

A calculation method when the braking/driving calculation unit 422 sets the braking force and the driving force will be described with reference to FIG. 13 to FIG. 15.

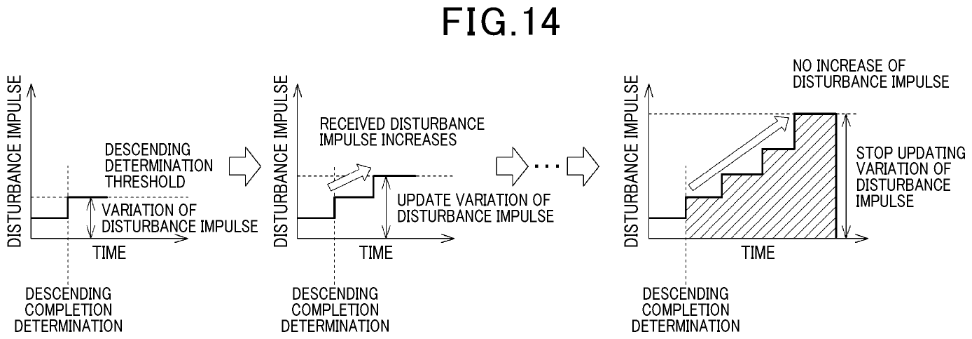

As described above, in response to the wheel of the running vehicle V descending from the step S, the vehicle speed rises than the target speed. Therefore, the automatic parking control device 40 gradually increases the set value of the braking force. Then, the disturbance impulse calculated by subtracting the braking/driving impulse from the velocity impulse increases in such a manner as to depart from 0 with the passage of time, as shown in FIG. 13 and FIG. 14. Specifically, the disturbance impulse increases stepwise with the passage of time such that the absolute value thereof increases.

Here, when the braking/driving calculation unit 422 increases the braking force when the vehicle speed and the target speed deviate from each other, the braking/driving calculation unit 422 increases the braking force by a previously set increase amount every control period. Therefore, the disturbance impulse which absolute value increases stepwise changes every control period depending on the variation of the braking force which increases by a previously set increase amount.

By the way, the variation of the disturbance impulse which increases by the wheel of the vehicle V descending from the step S is the variation of the disturbance impulse that increases every control period when the wheel of the vehicle V descends from the step S. This variation of the disturbance impulse is the variation of the impulse received by the vehicle V descending from the step S when descending from the step S. Then, the variation of the disturbance impulse is an excess disturbance impulse component which becomes a factor for abruptly rising of the vehicle speed of the vehicle V when the vehicle V descends from the step S.

Therefore, the braking force and the driving force after having descended from the step S are required to be set based on the variation of the disturbance impulse which increases by the wheel descending from the step S. Hereinafter, the variation of the disturbance impulse which changes after it is determined that the wheel of the vehicle V has descended from the step S is called a descending variation.

The braking/driving calculation unit 422 sets the braking force and the driving force immediately after the wheel of the vehicle V has descended from the step S based on the descending variation. In other words, the braking/driving calculation unit 422 calculates the braking force and the driving force immediately after the vehicle V has passed over the step S based on the variation of the disturbance impulse when passing over the step S.

Specifically, the braking/driving calculation unit 422 of the present embodiment maintains the driving force before descending from the step S as the set value of the driving force immediately after having descended from the step S, in order to prevent the vehicle V from abruptly accelerating immediately after the wheel has descended from the step S.

Further, the braking/driving calculation unit 422 brings the set value of the braking force immediately after having descended from the step S to be larger than the set value of the braking force at a timing at which it was determined in step S54 that the wheel has descended from the step S, in order to prevent the vehicle V from abruptly accelerating immediately after the wheel has descended from the step S. Thereafter, the braking/driving calculation unit 422 sets the set value of the braking force to be the same as the set value of the braking force before the wheel of the vehicle V descends from the step S, such that the vehicle speed approaches the target speed. Therefore, the braking/driving impulse based on the braking force and the driving force set by the braking/driving calculation unit 422 gradually increases from immediately after it was determined that the wheel has descended from the step S and thereafter gradually decreases, as shown in FIG. 13.

The braking/driving calculation unit 422 of the present embodiment sets the braking force immediately after having descended from the step S such that a difference between the absolute value of the braking/driving impulse after it was determined that the wheel has descended from the step S and the absolute value of the descending variation approaches 0. Specifically, the braking/driving calculation unit 422 sets the braking force immediately after having run on the step S such that the absolute value of the braking/driving impulse after it was determined that the wheel has descended from the step S is equal to the absolute value of the descending variation.

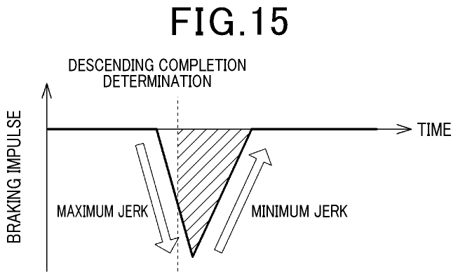

Here, the absolute value of the braking/driving impulse after it was determined that the wheel has descended from the step S is a braking/driving impulse component shown by slanted hatching shown in FIG. 15. Further, the variation of the disturbance impulse which changes after it is determined that the wheel of the vehicle V has descended from the step S is a disturbance impulse component shown by slanted hatching shown in FIG. 14. The braking/driving calculation unit 422 of the present embodiment sets the braking force immediately after having descending from the step S such that an area of a portion shown by slanted hatching of the disturbance impulse shown in FIG. 14 is equal to an area of a portion shown in slanted hatching of the braking/driving impulse shown in FIG. 15.

Further, when setting the braking force immediately after having descended from the step S to decelerate the vehicle V, the braking/driving calculation unit 422 sets the braking force such that the decrease amount of the acceleration per unit time of the vehicle V becomes the maximum jerk. Further, when accelerating the vehicle V after decelerating the vehicle V immediately after having run on the step S, the braking/driving calculation unit 422 sets the braking force such that the increase amount of the acceleration per unit time of the vehicle V becomes the minimum jerk.

Then, in step S58, the braking/driving calculation unit 422 transmits information of the calculated driving force and braking force immediately after having descended from the step S to the braking ECU 61 of the braking system 60.

Accordingly, the braking force output by the braking system 60 becomes smaller than the braking force immediately before it is determined that the wheel has descended from the step S. Specifically, the braking force output by the driving system 60 immediately after having descended from the step S gradually increases with the passage of time, as shown in FIG. 13. By controlling the braking force after having descended from the step S in this manner, abrupt acceleration of the vehicle V after the vehicle V has descended from the step S can be suppressed.

Then, in step S60, the automatic parking control device 40 determines whether an actual speed of the vehicle V detected by the speed sensor 31 deviates from the target speed. In response to determining that the actual speed deviates from the target speed, the automatic parking control device 40 repeatedly executes the process of step S56 to step S60 so that the braking/driving calculation unit 422 adjusts the set value of the braking force such that the vehicle speed approaches the target speed. On the other hand, in response to not determining that the actual speed deviates from the target speed, the automatic parking control device 40 executes the process of step S62.

Then, in step S62, the automatic parking control device 40 returns to the control before it is determined that the wheel of the vehicle V has descended from the step S. That is, the automatic parking control device 40 performs the process of step S100 to step S140 and performs the automatic parking action.

In the above-described manner, the braking/driving calculation unit 422 of the present embodiment calculates the driving force and the braking force based on the variation of the disturbance impulse when the vehicle has passed over the step S, in response to the step determination unit 44 determining that the vehicle has passed over the step S which is the change source.

Here, the disturbance impulse as the difference between the velocity impulse and the braking/driving impulse is an impulse that is received from disturbance when the vehicle V passes over the step S and that becomes a factor for the abrupt rise of the vehicle speed of the vehicle V after having passed over the step S. Therefore, the braking force and the driving force after having passed over the step S becoming excessive or insufficient can be suppressed by calculating the braking force and the driving force based on the variation of the disturbance impulse which becomes a factor for the abrupt rise of the vehicle speed of the vehicle V after having passed over the step S. Therefore, the braking force and the driving force of the vehicle V immediately after having passed over the step S can be appropriately controlled.

Further, according to the above-described embodiment, advantageous effects listed below can be achieved.
(1) In the above-described embodiment, the braking/driving calculation unit 422 calculates the driving force and the braking force such that a difference between the absolute value of the braking/driving impulse immediately after having run on the step S and the absolute value of the running-on variation approaches 0, in response to the step determination unit 44 determining that the wheel has run on the step S.

Here, the running-on variation that is the difference between the disturbance impulse when it was determined that the wheel has run on the step S and the disturbance impulse immediately before it is determined that the wheel has run on the step S is an excess disturbance impulse component which occurs when the wheel runs on the step S. Therefore, by setting the driving force and the braking force such that a difference between the absolute value of the braking/driving impulse immediately after having run on the step S and the absolute value of the running-on variation approaches 0, the braking/driving impulse immediately after having run on the step S can offset the running-on variation. Therefore, the braking force and the driving force of the vehicle V immediately after having run on the step S can be appropriately controlled such that the vehicle speed of the vehicle V after having run on the step S does not abruptly rise or such that the vehicle V does not decelerate more than necessary.
(2) In the above-described embodiment, the braking/driving calculation unit 422 calculates the driving force and the braking force such that a difference between the absolute value of the braking/driving impulse immediately after having descended from the step S and the absolute value of the descending variation approaches 0, in response to the step determination unit 44 determining that the wheel has descended from the step S.

Here, the descending variation that is the variation of the disturbance impulse after it was determined that the vehicle V has descended from the step S is an excess disturbance impulse component which is received from the step S by descending from the step S. Therefore, by setting the driving force and the braking force such that a difference between the absolute value of the braking/driving impulse immediately after having descended from the step S and the absolute value of the descending variation approaches 0, the braking/driving impulse immediately after having descended from the step S can offset the descending variation. Therefore, the braking force and the driving force of the vehicle V immediately after having descended from the step S can be appropriately controlled such that the vehicle speed of the vehicle V after having descended from the step S does not abruptly rise or decelerate more than necessary.
(3) In the above-described embodiment, the braking/driving calculation unit 422 calculates the driving force and the braking force such that the variation of the acceleration per unit time of the vehicle V becomes maximum, in decelerating the vehicle V when having passed over the step S.

By the way, it is desirable to decelerate the vehicle V as rapidly as possible in order to prevent the vehicle V from abruptly accelerating immediately after the vehicle V has run on the step S or immediately after the vehicle V has descended from the step S. However, it is difficult to momentarily decelerate the vehicle V to a necessary speed by the braking force and the driving force immediately after the wheel has run on the step S.

On the other hand, in decelerating the vehicle V, the vehicle V can be decelerated as rapidly as possible by calculating the driving force and the braking force such that the variation of the acceleration per unit time of the vehicle V becomes maximum.
(4) In the above-described embodiment, the braking/driving calculation unit 422 calculates the driving force and the braking force such that the variation of the acceleration per unit time of the vehicle V becomes maximum, in accelerating the vehicle V when having passed over the step S.

By the way, when bringing the speed of the vehicle V closer to the target speed after decelerating the vehicle V in order to prevent the vehicle V from abruptly accelerating immediately after the vehicle V has run on the step S or immediately after the vehicle V has descended from the step S, it is desirable to accelerate the vehicle V as rapidly as possible. However, it is difficult to momentarily accelerate the vehicle V to a necessary speed using the braking force and the driving force.

On the other hand, in accelerating the vehicle V, the vehicle V can be accelerated as rapidly as possible by calculating the driving force and the braking force such that the variation of the acceleration per unit time of the vehicle V becomes maximum.

### OTHER EMBODIMENTS

Although a representative embodiment of the present disclosure has been described, the present disclosure is not limited to the above-described embodiment, which can be variously modified, for example, as below.

In the above-described embodiment, an example in which the vehicle control device 1 is configured integrally with the automatic parking system and can execute the automatic parking process executed by the automatic parking system has been described. However, the present disclosure is not limited thereto.

For example, the vehicle control device 1 may be configured separately from the automatic parking system and uncapable of executing the automatic parking process. Then, the vehicle control device 1 may execute the above-described control process, not in the automatic parking process, but when the vehicle V is started by an operation of the driver and when the vehicle V is run due to an operation of the driver.

In the above-described embodiment, an example in which the change source is the step S has been described. However, the present disclosure is not limited thereto. The change source is one that has a predetermined height and prevents running of the vehicle V, and includes one other than the step S (for example, stone or the like) as long as it is one that changes the vehicle speed by the vehicle V passing over or descending from the change source.

In the above-described embodiment, an example in which the vehicle control device 1 is applied to the electric vehicle, and the torque sensor 34 detects as the driving force the output torque of the motor for running has been described. However, the present disclosure is not limited thereto.

For example, the vehicle control device 1 may be applied to a car having an engine as a driving source. In this case, the torque sensor 34 may be configured to directly detect as the driving force the driving force output by the engine or may be configured by an accelerator sensor that detects the driving force of the engine by detecting the operation amount of the accelerator pedal.

In the above-described embodiment, an example in which the braking/driving impulse is changed by increasing the braking force after having passed over the step S compared to the braking force before passing over the step S, in order to prevent the vehicle V from abruptly accelerating immediately after having run on the step S and immediately after having descended from the step S. However, the present disclosure is not limited thereto.

For example, in order to prevent the vehicle V from abruptly accelerating after having passed over the step S, the braking/driving impulse may be changed by decreasing the driving force after having passed over the step S compared to the driving force before passing over the step S. Alternatively, in order to prevent the vehicle V from abruptly accelerating after having passed over the step S, the braking/driving impulse may be changed by decreasing the driving force after having passed over the step S compared to the driving force before passing over the step S and also by increasing the braking force after having passed over the step S compared to the braking force before passing over the step S. In this case, the driving forces before and after passing over the step S may be adjusted by controlling the motor for running of the electric vehicle.

In the above-described embodiment, it is needless to say, elements constituting the embodiment are not necessarily essential except for when particularly specified as being essential or when considered as being apparently essential in principle.

When numerical values such as the quantities, numerical values, amounts, and ranges of the constituents of the embodiment are described in the above-described embodiment, the present disclosure is not limited to the specific numbers except for when particularly specified as being essential or when apparently limited to the specific numbers in principle.

When the shapes, positional relationships, and the like of the constituents are described in the above-described embodiment, the present disclosure is not limited to the shapes, positional relationships, and the like except for when particularly specified or when limited to the specific shapes, positional relationships, and the like in principle.

The control unit and the method therefor of the present disclosure may be realized by a dedicated computer provided by constituting a processor and a memory programmed to execute one or a plurality of functions embodied by a computer program. The control unit and the method therefor of the present disclosure may be realized by a dedicated computer provided by constituting a processor with one or more dedicated hardware logic circuits. The control unit and the method therefor of the present disclosure may be realized by one or more dedicated computers constituted by a combination of a processor and a memory programmed to execute one or a plurality of functions and a processer constituted by one or more hardware logic circuits. The computer program may be stored, as an instruction to be executed by the computer, in a computer-readable non-transitory tangible memory medium.

### ASPECTS OF PRESENT DISCLOSURE

The above-described present disclosure can be understood as, for example, the below-described aspects.

### First Aspect

A vehicle control device that controls a driving force and a braking force of a vehicle passing over a change source(S) which changes a vehicle speed by a wheel of the vehicle passing over or descending, including:
a passage determination unit (44) that determines that the vehicle has passed over the change source;
an impulse calculation unit (43) that calculates an impulse acting on the vehicle when the vehicle passes over the change source and that outputs impulse information corresponding to the calculated impulse; and
a braking/driving calculation unit (422) that calculates the driving force and the braking force after the vehicle has passed over the change source based on the impulse information, in which
the impulse calculation unit calculates a velocity impulse based on the vehicle speed which changes when passing over the change source and a braking/driving impulse based on the driving force and the braking force which change when passing over the change source, and
the braking/driving calculation unit calculates, in response to the passage determination unit determining that the vehicle has passed over the change source, the driving force and the braking force based on a variation of a disturbance impulse when having passed over the change source, when the disturbance impulse is a difference between the velocity impulse and the braking/driving impulse.

### Second Aspect

The vehicle control device according the first aspect, in which
the passage determination unit determines that the vehicle has run on the change source when the vehicle has run on the change source,
the impulse calculation unit calculates the velocity impulse and the braking/driving impulse when the vehicle runs on the change source, and
the braking/driving calculation unit calculates, in response to the passage determination unit determining that the vehicle has run on the change source, the driving force and the braking force such that a difference between an absolute value of the braking/driving impulse immediately after having run on the change source and an absolute value of a running-on variation approaches 0, when the running-on variation is a difference between the disturbance impulse when it was determined that the vehicle has run on the change source and the disturbance impulse immediately before it is determined that the vehicle has run on the change source.

### Third Aspect

The vehicle control device according to the first aspect, in which
the passage determination unit determines that the vehicle has descended from the change source when the vehicle has descended from the change source,
the impulse calculation unit calculates the velocity impulse and the braking/driving impulse when the vehicle descends from the change source, and
the braking/driving calculation unit calculates, in response to the passage determination unit determining that the vehicle has descended from the change source, the driving force and the braking force such that a difference between an absolute value of the braking/driving impulse immediately after having descended from the change source and an absolute value of a descending variation approaches 0, when the descending variation is a variation of the disturbance impulse after it was determined that the vehicle has descended from the change source.

### Fourth Aspect

The vehicle control device according to the second or third aspect, in which the braking/driving calculation unit calculates the driving force and the braking force such that a variation of an acceleration per unit time of the vehicle becomes maximum, in decelerating the vehicle when having passed over the change source, when the vehicle is capable of being decelerated by changing an acceleration of the vehicle by controlling the calculated driving force and the calculated braking force.

### Fifth Aspect

The vehicle control device according to the fourth aspect, in which the braking/driving calculation unit calculates the driving force and the braking force such that a variation of an acceleration per unit time of the vehicle becomes maximum, in accelerating the vehicle when having passed over the change source, when the vehicle is capable of being accelerated by changing an acceleration of the vehicle by controlling the calculated driving force and the calculated braking force.

What is claimed is:

1. A vehicle control device configured to control a driving force and a braking force of a vehicle passing over a change source which changes a vehicle speed by a wheel of the vehicle passing over or descending, comprising:
a passage determination unit configured to determine that the vehicle has passed over the change source;
an impulse calculation unit configured to calculate an impulse acting on the vehicle when the vehicle passes over the change source and that outputs impulse information corresponding to the calculated impulse; and
a braking/driving calculation unit configured to calculate the driving force and the braking force after the vehicle has passed over the change source based on the impulse information, wherein
the impulse calculation unit is configured to calculate a velocity impulse based on the vehicle speed which changes when passing over the change source and a braking/driving impulse based on the driving force and the braking force which change when passing over the change source, and
the braking/driving calculation unit configured to calculate, in response to the passage determination unit determining that the vehicle has passed over the change source, the driving force and the braking force based on a variation of a disturbance impulse when having passed over the change source, when the disturbance impulse is a difference between the velocity impulse and the braking/driving impulse.

2. The vehicle control device according to claim 1, wherein
the passage determination unit is configured to determine that the vehicle has run on the change source when the vehicle has run on the change source,
the impulse calculation unit is configured to calculate the velocity impulse and the braking/driving impulse when the vehicle runs on the change source, and
the braking/driving calculation unit is configured to calculate, in response to the passage determination unit determining that the vehicle has run on the change source, the driving force and the braking force such that a difference between an absolute value of the braking/driving impulse immediately after having run on the change source and an absolute value of a running-on variation approaches 0, the running-on variation being a difference between the disturbance impulse when it was determined that the vehicle has run on the change source and the disturbance impulse immediately before it is determined that the vehicle has run on the change source.

3. The vehicle control device according to claim 1, wherein
the passage determination unit is configured to determine that the vehicle has descended from the change source when the vehicle has descended from the change source,
the impulse calculation unit is configured to calculate the velocity impulse and the braking/driving impulse when the vehicle descends from the change source, and
the braking/driving calculation unit is configured to calculate, in response to the passage determination unit determining that the vehicle has descended from the change source, the driving force and the braking force such that a difference between an absolute value of the braking/driving impulse immediately after having descended from the change source and an absolute value of a descending variation approaches 0, the descending variation being a variation of the disturbance impulse after it was determined that the vehicle has descended from the change source.

4. The vehicle control device according to claim 2, wherein
the braking/driving calculation unit is capable of slowing down the vehicle by changing an acceleration of the vehicle by controlling the calculated driving force and the calculated braking force, and is configured to calculate the driving force and the braking force such that a variation of an acceleration per unit time of the vehicle becomes maximum, in decelerating the vehicle when having passed over the change source.

5. The vehicle control device according to claim 4, wherein
the braking/driving calculation unit is capable of accelerating the vehicle by changing an acceleration of the vehicle by controlling the calculated driving force and the calculated braking force, and is configured to calculate the driving force and the braking force such that a variation of an acceleration per unit time of the vehicle becomes maximum, in accelerating the vehicle when having passed over the change source, when the vehicle is capable of being accelerated by changing an acceleration of the vehicle by controlling the calculated driving force and the calculated braking force.
